(19) United States
(12) Patent Application Publication
(10) Pub. No.: US 2009/0220838 A9
(43) Pub. Date: Sep. 3, 2009

(54) SECONDARY ELECTROCHEMICAL CELL

(76) Inventors: Jeremy Barker, Shipton-Under Wychwood (GB); Richard Gover, Durham (GB); Paul Burns, Fifield (GB); Aiden Bryan, Jordanstown (GB)

Correspondence Address: VALENCE TECHNOLOGY, INC., 1889 E. MAULE AVENUE, SUITE A, LAS VEGAS, NV, 89119, US

(21) Appl. No.: 11/277,746

(22) Filed: Mar. 28, 2006

Related U.S. Application Data
(63) Continuation-in-part of application No. 10/906,182, filed on Feb. 7, 2005.
Application No. 10/906,182 is a division of application No. 10/115,787, filed on Apr. 4, 2002, now Pat. No. 6,872,492.
(60) Provisional application No. 60/666,132, filed on Mar. 28, 2005.
(60) Provisional application No. 60/729,932, filed on Oct. 25, 2005.

(51) Int. Cl. H01M 8/10

(52) U.S. Cl. 429/31

(57) ABSTRACT

The invention provides an electrochemical cell having a first electrode having an electrode active material containing at least one electrode active material charge-carrier, a second electrode, and an electrolyte containing at least one electrolyte charge-carrier. In the electrochemical cell's nascent state, the at least one electrolyte charge carrier differs from the at least one electrode active material charge-carrier.

This Application claims the benefit of Provisional Application Ser. No. 60/666,132 filed Mar. 28, 2005, and also claims the benefit of Provisional Application Ser. No.60/729,932 filed Oct. 25, 2005.

### FIELD OF THE INVENTION

This invention relates to an electrochemical cell employing an electrolyte containing a charge-carrier, and a positive electrode active material containing a charge-carrier, wherein in the electrochemical cell's nascent state, the charge carrier present in the electrolyte differs from the charge carrier present in the positive electrode active material.

### BACKGROUND OF THE INVENTION

A battery pack consists of one or more electrochemical cells or batteries, wherein each cell typically includes a positive electrode, a negative electrode, and an electrolyte or other material for facilitating movement of ionic charge carriers between the negative electrode and positive electrode. As the cell is charged, cations migrate from the positive electrode to the electrolyte and, concurrently, from the electrolyte to the negative electrode. During discharge, cations migrate from the negative electrode to the electrolyte and, concurrently, from the electrolyte to the positive electrode.

Prior-art electrochemical cells employing an alkali metal-based electrode active material employed an electrolyte having a salt of a corresponding alkali metal dissolved therein. Stated differently, the alkali metal of the electrode active material and the alkali metal were the same (e.g. use of LiPF₆ as an electrolyte salt in a cell containing LiCoO₂). Conventional wisdom has held that this was necessary in order to form a functional secondary electrochemical cell. Because lithium (Li) is best suited for intercalation with graphite-based electrodes (primarily because lithium forms a stable SEI layer on the graphite upon cycling), this necessitated use of a lithium-based electrolyte which, in turn necessitated used of a lithium-based intercalation active material for the positive electrode (cathode). This necessity has eliminated numerous lithium-based intercalation materials from actual and potential use in an electrochemical cell, due to the difficulty or high production cost associated with the synthesis of such lithium-based electrode materials.

However, analogs of many of such intercalation materials can be synthesized, and often with fewer synthesis steps and at a lesser material and production cost. Unfortunately, due to conventional wisdom, use of such analog electrode active materials in a positive electrode (cathode) has been attempted, because those skilled in the art were operating under the misconception that a lithium-based electrolyte could not be employed in a cell containing non-lithium based positive electrode active material. However, the inventors of the present invention have now proven that a non-lithium alkali or alkaline-based electrode active materials can be employed in a secondary electrochemical cell in conjunction with a lithium-based electrolyte.

### SUMMARY OF THE INVENTION

The present invention provides a novel secondary electrochemical cell employing an electrolyte containing one or more (i.e. at least one) charge-carriers, and a positive electrode active material containing one or more (i.e. at least one) charge-carriers, wherein in the electrochemical cell's nascent state, the charge carrier(s) present in the electrolyte differ from the charge carrier(s) present in the positive electrode active material.

In one embodiment, the electrode active material (in its nascent state) is represented by the general formula:
AₐM_{b}(M′O)_{c}(XY₄)_{d}OₑZ_{f};

wherein:
(i) A contains at least one element capable of forming a positive ion and undergoing deintercalation or deinsertion from the active material upon charge of the electrochemical cell, and 0<a≦9;
(ii) M and M′ are each selected from the group consisting of transition metals, non-transition metals and mixtures thereof, wherein M and M′ includes at least one redox active element, and 1≦b≦6 and 0≦c≦1;
(iii) XY₄ is selected from the group consisting of X′[O₄₋ₓ, Y′ₓ], X′[O_{4-y}, Y′_{2y}], X″S₄, [X_{z}′″,X′_{1-z}]O₄, WO₄, and mixtures thereof, wherein:
   (a) X′ and X′″ are each independently selected from the group consisting of P, As, Sb, Si, Ge, V, S, and mixtures thereof;
   (b) X″ is selected from the group consisting of P, As, Sb, Si, Ge, V, and mixtures thereof;
   (c) W is selected from the group consisting of V, Hf, Zr, Ti and mixtures thereof;
   (d) Y′ is selected from the group consisting of a halogen selected from Group 17 of the Periodic Table, S, N, and mixtures thereof; and
   (e) 0≦x≦3, 0≦y≦2, 0≦z≦1, and 0≦d≦3, wherein when e>0, c and d (c,d)=0, and when d>0, e=0;
(iv) O is oxygen, and 0≦e≦15, wherein when d>0, e=0; and
(v) Z is selected from the group consisting of a hydroxyl (OH), a halogen selected from Group 17 of the Periodic Table, nitrogen (N), and mixtures thereof, and 0≦f≦4; and

wherein M, X, Y, Z, a, b, c, x, y, z, d, e and f are selected so as to maintain electroneutrality of the material in its nascent or as-synthesized state.

In one embodiment, the secondary electrochemical cell is a cylindrical cell having a spirally coiled or wound electrode assembly enclosed in a cylindrical casing. In an alternate embodiment, the secondary electrochemical cell is a prismatic cell having a jellyroll-type electrode assembly enclosed in a cylindrical casing having a substantially rectangular cross-section. In yet another embodiment, the secondary electrochemical cell is a laminate-type cell.

In each embodiment described herein, the electrode assembly includes a separator interposed between a first electrode (positive electrode) containing an electrode active material described above and a counter second electrode (negative electrode), for electrically insulating the first electrode from the second electrode.

The electrochemical cell further includes a non-aqueous electrolyte. In the electrochemical cell's nascent state (namely, before the cell undergoes cycling), the non-aqueous electrolyte contains one or more charge carriers (e.g. Li⁺) that differ from the element(s) selected for moiety A of the positive electrode active material. In one preferred embodiment, the electrolyte is a lithium-based non-aqueous electrolyte. Stated differently, the positive electrode active materials is lithium-free in its nascent state.

### BRIEF DESCRIPTION OF THE DRAWINGS

FIG. 1 is a schematic cross-sectional diagram illustrating the structure of a non-aqueous electrolyte cylindrical electrochemical cell of the present invention.

FIG. 2 is a plot of cathode specific capacity vs. cell voltage for a graphite/1M LiPF₆ (EC/DMC)/Na₃V₂(PO₄)₂F₃ rocking chair cell and a.

FIG. 3 is a plot of differential capacity for a graphite/1M LiPF₆ (EC/DMC)/Na₃V₂(PO₄)₂F₃ rocking chair cell.

FIG. 4 is a cathode specific capacity plot for multiple cycles for a graphite/1M LiPF₆ (EC/DMC)/Na₃V₂(PO₄)₂F₃ rocking chair cell.

### DETAILED DESCRIPTION OF THE PREFERRED EMBODIMENTS

It has been found that the novel electrochemical cells of this invention afford benefits over such materials and devices among those known in the art. Such benefits include, without limitation, one or more of increased capacity, enhanced cycling capability, enhanced reversibility, enhanced ionic conductivity, enhanced electrical conductivity, enhanced rate capability, and reduced costs. Specific benefits and embodiments of the present invention are apparent from the detailed description set forth herein below. It should be understood, however, that the detailed description and specific examples, while indicating embodiments among those preferred, are intended for purposes of illustration only and are not intended to limit the scope of the invention.

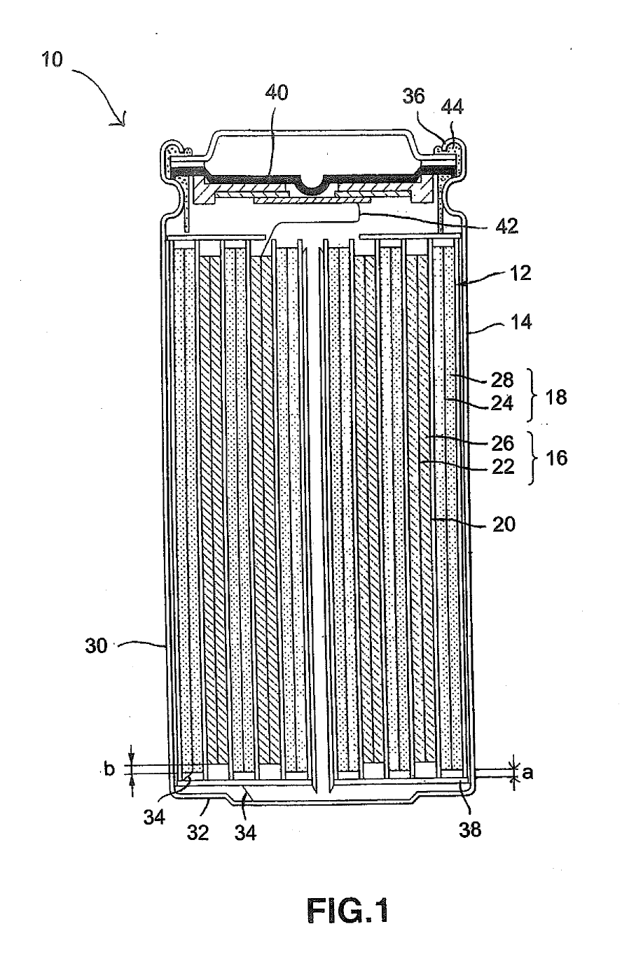

Referring to FIG. 1, a secondary electrochemical cell 10 having an electrode active material, preferably one described herein below as general formula (I), is illustrated. The cell 10 includes a spirally coiled or wound electrode assembly 12 enclosed in a sealed container, preferably a rigid cylindrical casing 14. The electrode assembly 12 includes: a first or positive electrode 16 consisting of, among other things, an electrode active material described herein below; a counter second or negative electrode 18; and a separator 20 interposed between the first and second electrodes 16,18. The separator 20 is preferably an electrically insulating, ionically conductive microporous film, and composed of a polymeric material selected from the group consisting of polyethylene, polyethylene oxide, polyacrylonitrile and polyvinylidene fluoride, polymethyl methacrylate, polysiloxane, copolymers thereof, and admixtures thereof.

Each electrode 16,18 includes a current collector 22 and 24, respectively, for providing electrical communication between the electrodes 16,18 and an external load. Each current collector 22,24 is a foil or grid of an electrically conductive metal such as iron, copper, aluminum, titanium, nickel, stainless steel, or the like, having a thickness of between 5 μm and 100 μm, preferably 5 μm and 20 μm. Optionally, the current collector may be treated with an oxide-removing agent such as a mild acid and the like, and coated with an electrically conductive coating for inhibiting the formation of electrically insulating oxides on the surface of the current collector 22,24. Examples of suitable coatings include polymeric materials comprising a homogenously dispersed electrically conductive material (e.g. carbon), such polymeric materials including: acrylics including acrylic acid and methacrylic acids and esters, including poly (ethylene-co-acrylic acid); vinylic materials including poly(vinyl acetate) and poly(vinylidene fluoride-co-hexafluoropropylene); polyesters including poly(adipic acid-co-ethylene glycol); polyurethanes; fluoroelastomers; and mixtures thereof.

The positive electrode 16 further includes a positive electrode film 26 formed on at least one side of the positive electrode current collector 22, preferably both sides of the positive electrode current collector 22, each film 26 having a thickness of between 10 μm and 150 μm, preferably between 25 μm an 125 μm, in order to realize the optimal capacity for the cell 10. The positive electrode film 26 is preferably composed of between 80% and 99% by weight of an electrode active material described herein below as general formula (I), between 1% and 10% by weight binder, and between 1% and 10% by weight electrically conductive agent.

Suitable binders include: polyacrylic acid; carboxymethylcellulose; diacetylcellulose; hydroxypropylcellulose; polyethylene; polypropylene; ethylene-propylene-diene copolymer; polytetrafluoroethylene; polyvinylidene fluoride; styrene-butadiene rubber; tetrafluoroethylene-hexafluoropropylene copolymer; polyvinyl alcohol; polyvinyl chloride; polyvinyl pyrrolidone; tetrafluoroethylene-perfluoroalkylvinyl ether copolymer; vinylidene fluoride-hexafluoropropylene copolymer; vinylidene fluoride-chlorotrifluoroethylene copolymer; ethylenetetrafluoroethylene copolymer; polychlorotrifluoroethylene; vinylidene fluoride-pentafluoropropylene copolymer; propylene-tetrafluoroethylene copolymer; ethylene-chlorotrifluoroethylene copolymer; vinylidene fluoride-hexafluoropropylene-tetrafluoroethylene copolymer; vinylidene fluoride-perfluoromethylvinyl ether-tetrafluoroethylene copolymer; ethylene-acrylic acid copolymer; ethylene-methacrylic acid copolymer; ethylene-methyl acrylate copolymer; ethylene-methyl methacrylate copolymer; styrene-butadiene rubber; fluorinated rubber; polybutadiene; and admixtures thereof. Of these materials, most preferred are polyvinylidene fluoride and polytetrafluoroethylene.

Suitable electrically conductive agents include: natural graphite (e.g. flaky graphite, and the like); manufactured graphite; carbon blacks such as acetylene black, Ketzen black, channel black, furnace black, lamp black, thermal black, and the like; conductive fibers such as carbon fibers and metallic fibers; metal powders such as carbon fluoride, copper, nickel, and the like; and organic conductive materials such as polyphenylene derivatives.

The negative electrode 18 is formed of a negative electrode film 28 formed on at least one side of the negative electrode current collector 24, preferably both sides of the negative electrode current collector 24. The negative electrode film 28 is composed of between 80% and 95% of an intercalation material, between 2% and 10% by weight binder, and (optionally) between 1% and 10% by of an weight electrically conductive agent.

Intercalation materials suitable herein include: transition metal oxides, metal chalcogenides, carbons (e.g. graphite), and mixtures thereof capable of intercalating the alkali metal-ions present in the electrolyte in the electrochemical cell's nascent state,

In one embodiment, the intercalation material is selected from the group consisting of crystalline graphite and amorphous graphite, and mixtures thereof, each such graphite having one or more of the following properties: a lattice interplane (002) d-value (d₍₀₀₂₎) obtained by X-ray diffraction of between 3.35 Å to 3.34 Å, inclusive (3.35 Å≦d₍₀₀₂₎≦3.34 Å), preferably 3.354 Å to 3.370 Å, inclusive (3.354 Å ≦d₍₀₀₂₎≦3.370 Å; a crystallite size (L_{c}) in the c-axis direction obtained by X-ray diffraction of at least 200 Å, inclusive (L_{c}≧200 Å), preferably between 200 Å and 1,000 Å, inclusive (200 Å ≦L_{c}≦1,000 Å); an average particle diameter (P_{d}) of between 1 μm to 30 μm, inclusive (1 μm≦P_{d}≦30 μm); a specific surface (SA) area of between 0.5 m²/g to 50 m²/g, inclusive (0.5 m²/g≦SA≦50 m²/g); and a true density (ρ) of between 1.9 g/cm³to 2.25 g/cm³, inclusive (1.9 g/cm³≦ρ≦2.25 g/cm³).

Referring again to FIG. 1, to ensure that the electrodes 16,18 do not come into electrical contact with one another, in the event the electrodes 16,18 become offset during the winding operation during manufacture, the separator 20 “overhangs” or extends a width “a” beyond each edge of the negative electrode 18. In one embodiment, 50 μm≦a≦2,000 μm. To ensure alkali metal does not plate on the edges of the negative electrode 18 during charging, the negative electrode 18 “overhangs” or extends a width “b” beyond each edge of the positive electrode 16. In one embodiment, 50 μm≦b≦2,000 μm.

The cylindrical casing 14 includes a cylindrical body member 30 having a closed end 32 in electrical communication with the negative electrode 18 via a negative electrode lead 34, and an open end defined by crimped edge 36. In operation, the cylindrical body member 30, and more particularly the closed end 32, is electrically conductive and provides electrical communication between the negative electrode 18 and an external load (not illustrated). An insulating member 38 is interposed between the spirally coiled or wound electrode assembly 12 and the closed end 32.

A positive terminal subassembly 40 in electrical communication with the positive electrode 16 via a positive electrode lead 42 provides electrical communication between the positive electrode 16 and the external load (not illustrated). Preferably, the positive terminal subassembly 40 is adapted to sever electrical communication between the positive electrode 16 and an external load/charging device in the event of an overcharge condition (e.g. by way of positive temperature coefficient (PTC) element), elevated temperature and/or in the event of excess gas generation within the cylindrical casing 14. Suitable positive terminal assemblies 40 are disclosed in U.S. Pat. No. 6,632,572 to Iwaizono, et al., issued Oct. 14, 2003; and U.S. Pat. No. 6,667,132 to Okochi, et al., issued Dec. 23, 2003. A gasket member 42 sealingly engages the upper portion of the cylindrical body member 30 to the positive terminal subassembly 40.

A non-aqueous electrolyte (not shown) is provided for transferring ionic charge carriers between the positive electrode 16 and the negative electrode 18 during charge and discharge of the electrochemical cell 10. The electrolyte includes a non-aqueous solvent and an alkali metal salt dissolved therein capable of forming a stable SEI layer on the negative electrode (most preferably, a lithium salt). In the electrochemical cell's nascent state (namely, before the cell undergoes cycling), the non-aqueous electrolyte contains a charge carrier other than the element(s) selected for moiety A of the electrode active material.

Suitable solvents include: a cyclic carbonate such as ethylene carbonate, propylene carbonate, butylene carbonate or vinylene carbonate; a non-cyclic carbonate such as dimethyl carbonate, diethyl carbonate, ethyl methyl carbonate or dipropyl carbonate; an aliphatic carboxylic acid ester such as methyl formate, methyl acetate, methyl propionate or ethyl propionate; a .gamma.-lactone such as γ-butyrolactone; a non-cyclic ether such as 1,2-dimethoxyethane, 1,2-diethoxyethane or ethoxymethoxyethane; a cyclic ether such as tetrahydrofuran or 2-methyltetrahydrofuran; an organic aprotic solvent such as dimethylsulfoxide, 1,3-dioxolane, formamide, acetamide, dimethylformamide, dioxolane, acetonitrile, propylnitrile, nitromethane, ethyl monoglyme, phospheric acid triester, trimethoxymethane, a dioxolane derivative, sulfolane, methylsulfolane, 1,3-dimethyl-2-imidazolidinone, 3-methyl-2-oxazolidinone a propylene carbonate derivative, a tetrahydrofuran derivative, ethyl ether, 1,3-propanesultone, anisole, dimethylsulfoxide and N-methylpyrrolidone; and mixtures thereof. A mixture of a cyclic carbonate and a non-cyclic carbonate or a mixture of a cyclic carbonate, a non-cyclic carbonate and an aliphatic carboxylic acid ester, are preferred.

Suitable alkali metal salts, particularly lithium salts, include (along with their sodium analogues): LiClO₄; LiBF₄; LiPF₆; LiAlCl₄; LiSbF₆; LiSCN; LiCF₃SO₃; LiCF₃CO₂; Li(CF₃SO₂)₂; LiAsF₆; LiN(CF₃SO2)₂; LiB₁₀Cl₁₀; a lithium lower aliphatic carboxylate; LiCl; LiBr; Lil; a chloroboran of lithium; lithium tetraphenylborate; lithium imides; and mixtures thereof. Preferably, the electrolyte contains at least LiPF₆.

As noted herein above, the positive electrode film 26 contains a positive electrode active material wherein, in the electrochemical cell's nascent state, the charge carrier(s) present in the positive electrode active material differs from the charge carrier(s) present in the electrolyte. As used herein, a “positive electrode active material charge carrier” refers to an element capable of forming a positive ion and undergoing deintercalation (or deinsertion) from the active material upon the first charge of an electrochemical cell containing the same. As used herein, an “electrolyte charge carrier” refers to an ion present in the electrolyte in the electrochemical cell's nascent state.

In one embodiment, the positive electrode active material, in its nascent state, is represented by the general formula (I):
AₐM_{b}(M′O)_{c}(XY₄)_{d}OₑZ_{f}. (I)

For all embodiments described herein, the electrode active materials described herein are in their nascent or as-synthesized state, prior to undergoing cycling in an electrochemical cell. The components of the electrode active material are selected so as to maintain electroneutrality of the electrode active material. The stoichiometric values of one or more elements of the composition may take on non-integer values.

For all embodiments described herein, moiety A contains at least one positive electrode active material charge carrier. Stated differently, A contains at least one element capable of forming a positive ion and undergoing deintercalation (or deinsertion) from the active material upon the first charge of an electrochemical cell containing the same, wherein 0<a≦9. In one embodiment, A is selected from the group consisting of elements from Groups I and II of the Periodic Table, and mixtures thereof (e.g. Aₐ=A_{a-a′}A′_{a′}, wherein A and A′ are each selected from the group consisting of elements from Groups I and II of the Periodic Table and are different from one another, and a′<a). In one subembodiment, in the material's as-synthesized or nascent state, A does not include lithium (Li). In another subembodiment, in the material's as-synthesized or nascent state, A does not include lithium (Li) or sodium (Na).

As referred to herein, “Group” refers to the Group numbers (i.e., columns) of the Periodic Table as defined in the current IUPAC Periodic Table. (See, e.g., U.S. Pat. No. 6,136,472, Barker et al., issued Oct. 24, 2000, incorporated by reference herein.) In addition, the recitation of a genus of elements, materials or other components, from which an individual component or mixture of components can be selected, is intended to include all possible sub-generic combinations of the listed components, and mixtures thereof.

Preferably, a sufficient quantity (a) of moiety A should be present so as to allow all of the “redox active” elements of moiety M (as defined herein below) to undergo oxidation/reduction. Removal of an amount (a) of moiety A from the electrode active material is accompanied by a change in oxidation state of at least one of the “redox active” elements in the active material, as defined herein below. The amount of redox active material available for oxidation/reduction in the active material determines the amount (a) of moiety A that may be removed. Such concepts are, in general application, well known in the art, e.g., as disclosed in U.S. Pat. No. 4,477,541, Fraioli, issued Oct. 16, 1984; and U.S. Pat. No. 6,136,472, Barker, et al., issued Oct. 24, 2000, both of which are incorporated by reference herein.

For all embodiments described herein, moiety A may be partially substituted by moiety D by aliovalent or isocharge substitution, in equal or unequal stoichiometric amounts, wherein:
(a) Aₐ=[A_{a-g},D_{h/V}_{^{D}}],
(b) D is an element other than the alkali metal charge carrier present in the electrolyte in the electrochemical cell's nascent state;
(c) V^{D} is the oxidation state of moiety D;
(d) V^{A}=V^{D} or V^{A}≠V^{D};
(e) g=h or f≠h; and
(f) g,h>0and g≦a.

“Isocharge substitution” refers to a substitution of one element on a given crystallographic site with an element having the same oxidation state (e.g. substitution of Ca²⁺ with Mg²⁺). “Aliovalent substitution” refers to a substitution of one element on a given crystallographic site with an element of a different oxidation state (e.g. substitution of Na⁺ with Mg²⁺).

Preferably, moiety D is at least one element preferably having an atomic radius substantially comparable to that of moiety A. In one embodiment, D is at least one transition metal. Examples of transition metals useful herein with respect to moiety D include, without limitation, Nb (Niobium), Zr (Zirconium), Ti (Titanium), Ta (Tantalum), Mo (Molybdenum), W (Tungsten), and mixtures thereof. In another embodiment, moiety D is at least one element characterized as having a valence state of ≧2+ and an atomic radius that is substantially comparable to that of the moiety being substituted (e.g. M and/or A). Unless otherwise specified, a variable described herein algebraically as equal to (“=”), less than or equal to (“≦”), or greater than or equal to (“≧”) a number is intended to subsume values or ranges of values about equal or functionally equivalent to said number.

With respect to moiety A, examples of such elements include, without limitation, Nb (Niobium), Mg (Magnesium) and Zr (Zirconium). Preferably, the valence or oxidation state of D (V^{D}) is greater than the valence or oxidation state of the moiety (or sum of oxidation states of the elements consisting of the moiety) being substituted for by moiety D (e.g. moiety M and/or moiety A).

For all embodiments described herein where moiety A is partially substituted by moiety D by isocharge substitution, A may be substituted by an equal stoichiometric amount of moiety D, wherein g,h>0, g≦a, and g=h.

Where moiety A is partially substituted by moiety D by isocharge substitution and g≠h, then the stoichiometric amount of one or more of the other components (e.g. A, M, XY₄ and Z) in the active material must be adjusted in order to maintain electroneutrality.

For all embodiments described herein where moiety A is partially substituted by moiety D by aliovalent substitution, moiety A may be substituted by an “oxidatively” equivalent amount of moiety D, wherein: g=h; g,h>0; and g≦a.

Where moiety is partially substituted by moiety D by aliovalent substitution and d≠f, then the stoichiometric amount of one or more of the other components (e.g. A, M, (M′O), XY₄, O and Z) in the active material must be adjusted in order to maintain electroneutrality.

Referring again to general formula (I), in all embodiments described herein, at least one of M and M′ includes at least one redox active element, and 1≦b≦6. In one embodiment, moieties M and M′ are independently selected from the group consisting of transition metals, non-transition metals, and mixtures thereof, wherein. As used herein, the term “redox active element” includes those elements characterized as being capable of undergoing oxidation/reduction to another oxidation state when the electrochemical cell is operating under normal operating conditions. As used herein, the term “normal operating conditions” refers to the intended voltage at which the cell is charged, which, in turn, depends on the materials used to construct the cell.

Redox active elements useful herein with respect to moieties M and M′ include, without limitation, elements from Groups 4 through 11 of the Periodic Table, as well as select non-transition metals, including, without limitation, Ti (Titanium), V (Vanadium), Cr (Chromium), Mn (Manganese), Fe (Iron), Co (Cobalt), Ni (Nickel), Cu (Copper), Nb (Niobium), Mo (Molybdenum), Ru (Ruthenium), Rh (Rhodium), Pd (Palladium), Os (Osmium), Ir (Iridium), Pt (Platinum), Au (Gold), Si (Silicon), Sn (Tin), Pb (Lead), and mixtures thereof. For each embodiment described herein, M and/or M′ may comprise a mixture of oxidation states for the selected element (e.g., M/M′=Mn²⁺Mn⁴⁺.

In one embodiment, moiety M and/or M′ is a redox active element. In one subembodiment, M is a redox active element selected from the group consisting of Ti²⁺, V²⁺, Cr²⁺, Mn²⁺, Fe²⁺, Co²⁺, Ni²⁺, Cu²⁺, Mo²⁺, Si²⁺, Sn²⁺, and Pb²⁺. In another subembodiment, M is a redox active element selected from the group consisting of Ti³⁺, V³⁺, Cr³⁺, Mn³⁺, Fe³⁺, Co³⁺, Ni³⁺, Mo³⁺, and Nb³⁺.

In another embodiment, moieties M and/or M′ include one or more redox active elements and (optionally) one or more non-redox active elements. As referred to herein, “non-redox active elements” include elements that are capable of forming stable active materials, and do not undergo oxidation/reduction when the electrode active material is operating under normal operating conditions.

Among the non-redox active elements useful herein include, without limitation, those selected from Group 2 elements, particularly Be (Beryllium), Mg (Magnesium), Ca (Calcium), Sr (Strontium), Ba (Barium); Group 3 elements, particularly Sc (Scandium), Y (Yttrium), and the lanthanides, particularly La (Lanthanum), Ce (Cerium), Pr (Praseodymium), Nd (Neodymium), Sm (Samarium); Group 12 elements, particularly Zn (Zinc) and Cd (Cadmium); Group 13 elements, particularly B (Boron), Al (Aluminum), Ga (Gallium), In (Indium), Tl (Thallium); Group 14 elements, particularly C (Carbon) and Ge (Germanium), Group 15 elements, particularly As (Arsenic), Sb (Antimony), and Bi (Bismuth); Group 16 elements, particularly Te (Tellurium); and mixtures thereof.

In one embodiment, M and/or M′=MIₙMIIₒ, wherein 0<o+n≦b and each of o and n is greater than zero (0<o,n), wherein MI and MII are each independently selected from the group consisting of redox active elements and non-redox active elements, wherein at least one of MI and MII is redox active. MI may be partially substituted with MII by isocharge or aliovalent substitution, in equal or unequal stoichiometric amounts.

For all embodiments described herein where MI is partially substituted by MII by isocharge substitution, MI may be substituted by an equal stoichiometric amount of MII, whereby M=MIₙ₋ₒMIIₒ. Where MI is partially substituted by MII by isocharge substitution and the stoichiometric amount of MI is not equal to the amount of MII, whereby M=MIₙ₋ₒMIIₚ and o≠p, then the stoichiometric amount of one or more of the other components (e.g. A, D, XY₄, O and Z) in the active material must be adjusted in order to maintain electroneutrality.

For all embodiments described herein where MI is partially substituted by MII by aliovalent substitution and an equal amount of MI is substituted by an equal amount of MII, whereby M=MIₙ₋ₒMIIₒ, then the stoichiometric amount of one or more of the other components (e.g. A, D, XY₄, O and Z) in the active material must be adjusted in order to maintain electroneutrality. However, MI may be partially substituted by MII by aliovalent substitution by substituting an “oxidatively” equivalent amount of MII for MI (e.g. whereby M=MI_{n-o/V}_{^{MI}}MII_{o/V}_{^{MII}}, wherein V^{MI} is the oxidation state of MI, and V^{MII} is the oxidation state of MII).

In one subembodiment, MI is selected from the group consisting of Ti, V, Cr, Mn, Fe, Co, Ni, Cu, Mo, Si, Pb, Mo, Nb, and mixtures thereof, and MII is selected from the group consisting of Be, Mg, Ca, Sr, Ba, Sc, Y, Zn, Cd, B, Al, Ga, In, C, Ge, and mixtures thereof. In this subembodiment, MI may be substituted by MII by isocharge substitution or aliovalent substitution.

In another subembodiment, MI is partially substituted by MII by isocharge substitution. In one aspect of this subembodiment, MI is selected from the group consisting of Ti²⁺, V²⁺, Cr²⁺, Mn²⁺, Fe²⁺, Co²⁺, Ni²⁺, Cu²⁺, Mo²⁺, Si²⁺, Sn²⁺, Pb²⁺, and mixtures thereof, and MII is selected from the group consisting of Be²⁺, Mg²⁺, Ca²⁺, Sr²⁺, Ba²⁺, Zn²⁺, Cd²⁺, Ge²⁺, and mixtures thereof. In another aspect of this subembodiment, MI is selected from the group specified immediately above, and MII is selected from the group consisting of Be²⁺, Mg²⁺, Ca²⁺, Sr²⁺, Ba²⁺, and mixtures thereof. In another aspect of this subembodiment, MI is selected from the group specified above, and MII is selected from the group consisting of Zn²⁺, Cd²⁺, and mixtures thereof In yet another aspect of this subembodiment, MI is selected from the group consisting of Ti³⁺, V³⁺, Cr³⁺, Mn³⁺, Fe³⁺, Co³⁺, Ni³⁺, Mo³⁺, Nb³⁺, and mixtures thereof, and MII is selected from the group consisting of Sc³⁺, Y³⁺, B³⁺, Al³⁺, Ga³⁺, In³⁺, and mixtures there

In another embodiment, MI is partially substituted by MII by aliovalent substitution. In one aspect of this subembodiment, MI is selected from the group consisting of Ti²⁺, V²⁺, Cr²⁺, Mn²⁺, Fe²⁺, Co²⁺, Ni²⁺, Cu²⁺, Mo²⁺, Si²⁺, Sn²⁺, Pb²⁺, and mixtures thereof, and MII is selected from the group consisting of Sc³⁺, Y³⁺, B³⁺, Al³⁺, Ga³⁺, In³⁺, and mixtures thereof. In another aspect of this subembodiment, MI is a 2+ oxidation state redox active element selected from the group specified immediately above, and MII is selected from the group consisting of alkali metals, Cu¹⁺, Ag¹⁺ and mixtures thereof. In another aspect of this subembodiment, MI is selected from the group consisting of Ti³⁺, V³⁺, Cr³⁺, Mn³⁺, Fe³⁺, Co³⁺, Ni³⁺, Mo³⁺, Nb³⁺, and mixtures thereof, and MII is selected from the group consisting of Be²⁺, Mg²⁺, Ca²⁺, Sr²⁺, Ba²⁺, Zn²⁺, Cd²⁺, Ge²⁺, and mixtures thereof. In another aspect of this subembodiment, MI is a 3+ oxidation state redox active element selected from the group specified immediately above, and MII is selected from the group consisting of alkali metals, Cu¹⁺, Ag¹⁺ and mixtures thereof.

In another embodiment, M and/or M′=M1_{q}M2ᵣM3ₛ, wherein:
(i) MI is a redox active element with a 2+ oxidation state;
(ii) M2 is selected from the group consisting of redox and non-redox active elements with a 1+ oxidation state;
(iii) M3 is selected from the group consisting of redox and non-redox active elements with a 3+ or greater oxidation state; and
(iv) at least one of q, r and s is greater than 0, and at least one of M1, M2, and M3 is redox active.

In one subembodiment, M1 is substituted by an equal amount of M2 and/or M3, whereby q=q−(r+s). In this subembodiment, then the stoichiometric amount of one or more of the other components (e.g. A, XY₄, Z) in the active material must be adjusted in order to maintain electroneutrality.

In another subembodiment, M¹ is substituted by an “oxidatively” equivalent amount of M²and/or M³ (e.g. whereby

$$M = M {1}_{q - \frac{r}{{V}^{M 1}} \frac{s}{{V}^{M 1}}} M {2}_{\frac{r}{{V}^{M 2}}} M {3}_{\frac{s}{{V}^{M 3}}} ,$$

wherein V^{M1} is the oxidation state of M1, V^{M2} is the oxidation state of M2, and V^{M3} is the oxidation state of M3).

In one subembodiment, M1 is selected from the group consisting of Ti²⁺, V²⁺, Cr²⁺, Mn²⁺, Fe²⁺, Co²⁺, Ni²⁺, Cu²⁺, Mo²⁺, Si²⁺, Sn²⁺, Pb²⁺, and mixtures thereof; M2 is selected from the group consisting of Cu¹⁺, Ag¹⁺ and mixtures thereof; and M3 is selected from the group consisting of Ti³⁺, V³⁺, Cr³⁺, Mn³⁺, Fe³⁺, Co³⁺, Ni³⁺, Mo³⁺, Nb³⁺, and mixtures thereof. In another subembodiment, M1 and M3 are selected from their respective preceding groups, and M2 is selected from the group consisting of Li¹⁺, K¹⁺, Na¹⁺, Ru¹⁺, Cs¹⁺, and mixtures thereof.

In another subembodiment, M1 is selected from the group consisting of Be²⁺, Mg²⁺, Ca²⁺, Sr²⁺, Ba²⁺, Zn²⁺, Cd²⁺, Ge²⁺, and mixtures thereof; and M3 is selected from the group consisting of Cu¹⁺, Ag¹⁺ and mixtures thereof; and M3 is selected from the group consisting of Ti³⁺, V³⁺, Cr³⁺, Mn³⁺, Fe³⁺, Co³⁺, Ni³⁺, Mo³⁺, Nb³⁺, and mixtures thereof. In another subembodiment, M1 and M3 are selected from their respective preceding groups, and M2 is selected from the group consisting of Li¹⁺, K¹⁺, Na¹⁺, Ru¹⁺, Cs¹⁺, and mixtures thereof.

In another subembodiment, M1 is selected from the group consisting of Ti²⁺, V²⁺, Cr²⁺, Mn²⁺, Fe²⁺, Co²⁺, Ni²⁺, Cu²⁺, Mo²⁺, Si²⁺, Sn²⁺, Pb²⁺, and mixtures thereof; M2 is selected from the group consisting of Cu¹⁺, Ag¹⁺, and mixtures thereof; and M3 is selected from the group consisting of Sc³⁺, Y³⁺, B³⁺, Al³⁺, Ga³⁺, In³⁺, and mixtures thereof. In another subembodiment, M1 and M3 are selected from their respective preceding groups, and M2 is selected from the group consisting of Li¹⁺, K¹⁺, Na¹⁺, Ru¹⁺, Cs¹⁺, and mixtures thereof.

In all embodiments described herein, moiety XY₄ is a polyanion selected from the group consisting of X′[O₄₋ₓ, Y′ₓ], X′[O_{4-y}, Y′_{2y}], X″S₄, [X_{z}′″,X′_{1-z}]O₄, WO₄, and mixtures thereof, wherein:
(a) X′ and X′″ are each independently selected from the group consisting of P, As, Sb, Si, Ge, V, S, and mixtures thereof;
(b) X″ is selected from the group consisting of P, As, Sb, Si, Ge, V, and mixtures thereof;
(c) W is selected from the group consisting of V, Hf, Zr, Ti and mixtures thereof;
(d) Y′ is selected from the group consisting of a halogen, S, N, and mixtures thereof; and
(e) 0≦x≦3, 0≦y≦2, 0≦z≦1, and 0≦d≦3, when e>0, c and d (c,d)=0, and when d>0, e=0.

In one subembodiment, XY₄ is selected from the group consisting of X′O₄₋ₓY′ₓ, X′O_{4-y}Y′_{2y}, and mixtures thereof, and x and y are both 0 (x,y=0). Stated otherwise, XY₄ is a polyanion selected from the group consisting of PO₄, SiO₄, GeO₄, VO₄, AsO₄, SbO₄, SO₄, and mixtures thereof. Preferably, XY₄ is PO₄ (a phosphate group) or a mixture of PO₄ with another anion of the above-noted group (i.e., where X′ is not P, Y′ is not O, or both, as defined above). In one embodiment, XY₄ includes about 80% or more phosphate and up to about 20% of one or more of the above-noted anions.

In another subembodiment, XY₄ is selected from the group consisting of X′[O₄₋ₓ,Y′ₓ], X′[O_{4-y},Y′_{2y}], and mixtures thereof, and 0<x≦3 and 0<y≦2, wherein a portion of the oxygen (O) in the XY₄ moiety is substituted with a halogen, S, N, or a mixture thereof.

In another subembodiment, XY₄=WO₄ wherein W is selected from the group consisting of V, Hf, Zr, Ti and mixtures thereof. In another subembodiment, W is selected from the group consisting of Zr and Ti.

In all embodiments described herein, moiety Z (when provided) is selected from the group consisting of OH (Hydroxyl), nitrogen (N), a halogen, or mixtures thereof, wherein 0≦f≦4. In one embodiment, Z is selected from the group consisting of OH, F (Fluorine), Cl (Chlorine), Br (Bromine), and mixtures thereof. In another embodiment, Z is OH. In another embodiment, Z is F, or a mixture of F with OH, Cl, or Br.

The composition of the electrode active material, as well as the stoichiometric values of the elements of the composition, are selected so as to maintain electroneutrality of the electrode active material. The stoichiometric values of one or more elements of the composition may take on non-integer values. Preferably, the XY₄ moiety is, as a unit moiety, an anion having a charge of −2, −3, or −4, depending on the selection of X′, X″, X′″, Y′, and x and y. When XY₄ is a mixture of polyanions such as the preferred phosphate/phosphate substitutes discussed above, the net charge on the XY₄ anion may take on non-integer values, depending on the charge and composition of the individual groups XY₄ in the mixture.

In one particular subembodiment, the positive electrode film 26 contains an electrode active material represented by the general formula (II):
AₐM_{b}(XY₄)_{d}Z_{f}, (II)

wherein:
(i) moieties A, M, and Z are as described herein above, wherein 0<a≦9,1≦b≦3, and 0≦f≦4; and
(ii) XY₄ is selected from the group consisting of X′[O₄₋ₓ,Y′ₓ], X′[O_{4-y}Y′_{2y}], X″S₄, [X_{z}′″,X′_{1-z}]O₄, and mixtures thereof, wherein:
   (a) X′ and X′″ are each independently selected from the group consisting of P, As, Sb, Si, Ge, V, S, and mixtures thereof;
   (b) X″ is selected from the group consisting of P, As, Sb, Si, Ge, V, and mixtures thereof;
   (c) Y′ is selected from the group consisting of a halogen, S, N, and mixtures thereof; and
   (d) 0≦x≦3, 0≦y≦2, 0≦z≦1, and 1≦d≦3; and

wherein A, M, X, Y, Z, a, b, x, y, z, and f are selected so as to maintain electroneutrality of the material in its nascent or as-synthesized state.

In one particular subembodiment, M of general formula (II) is selected from the group consisting of Ti³⁺, V³⁺, Cr³⁺, Mn³⁺, Fe³⁺, Co³⁺, Ni³⁺, Mo³⁺, Nb³⁺, and mixtures thereof (preferably V³⁺), XY₄=PO₄, d=3 and f=0. In another subembodiment, M of general formula (II) is selected from the group consisting of Ti²⁺, V²⁺, Cr²⁺, Mn²⁺, Fe²⁺, Co²⁺, Ni²⁺, Cu²⁺, Mo²⁺, Si²⁺, Sn²⁺, Pb²⁺, and mixtures thereof (preferably Fe²⁺, XY₄=PO₄, d=1 and f=0.

In one particular subembodiment, M of general formula (II) is selected from the group consisting of Ti³⁺, V³⁺, Cr³⁺, Mn³⁺, Fe³⁺, Co³⁺, Ni³⁺, Mo³⁺, Nb³⁺, and mixtures thereof (preferably V³⁺), XY₄=PO₄, and d=2.

Methods of making the electrode active materials described by general formula (II) are well known in the art, and are described in: WO 01/54212 to Barker et al., published Jul. 26, 2001; International Publication No. WO 98/12761 to Barker et al., published Mar. 26, 1998; WO 00/01024 to Barker et al., published Jan. 6, 2000; WO 00/31812 to Barker et al., published Jun. 2, 2000; WO 00/57505 to Barker et al., published Sep. 28, 2000; WO 02/44084 to Barker et al., published Jun. 6, 2002; WO 03/085757 to Saidi et al., published Oct. 16, 2003; WO 03/085771 to Saidi et al., published Oct. 16, 2003; WO 03/088383 to Saidi et al., published Oct. 23, 2003; U.S. Pat. No. 6,528,033 to Barker et al., issued Mar. 4, 2003; U.S. Pat. No. 6,387,568 to Barker et al., issued May 14, 2002; U.S. Publication No. 2003/0027049 to Barker et al., published Feb. 2, 2003; U.S. Publication No. 2002/0192553 to Barker et al., published Dec. 19, 2002; U.S. Publication No. 2003/0170542 to Barker at al., published Sep. 11, 2003; and U.S. Publication No. 2003/1029492 to Barker et al., published Jul. 10, 2003; the teachings of all of which are incorporated herein by reference.

Non-limiting examples of active materials of this subembodiment and represented by general formulas (I) and (II) include the following: Na_{0.95}Co_{0.8}Fe_{0.15}Al_{0.05}PO₄, Na_{1.025}Co_{0.85}Fe_{0.05}Al_{0.025}Mg_{0.05}PO₄, Na_{1.025}Co_{0.80}Fe_{0.10}Al_{0.025}Mg_{0.05}PO₄, Na_{1.025}Co_{0.45}Fe_{0.45}Al_{0.025}Mg_{0.05}PO₄, Na_{1.025}Co_{0.75}Fe_{0.15}Al_{0.025}Mg_{0.05}PO₄, Na_{1.025}Co_{0.7}(Fe_{0.4}Mn_{0.6})_{0.2}Al_{0.025}Mg_{0.05}PO₄, Na_{1.025}Co_{0.75}Fe_{0.15}Al_{0.025}Mg_{0.05}PO₄, Na_{1.025}Co_{0.85}Fe_{0.05}Al_{0.025}Mg_{0.05}PO₄, Na_{1.025}Co_{0.7}Fe_{0.08}Mn_{0.12}Al_{0.025}Mg_{0.05}PO₄, NaCo_{0.75}Fe_{0.15}Al_{0.025}Ca_{0.05}PO_{3.975}F_{0.025}, NaCo_{0.80}Fe_{0.10}Al_{0.025}Ca_{0.05}PO_{3.975}F_{0.25}, Na_{1.25}Co_{0.6}Fe_{0.1}Mn_{0.075}Mg_{0.025}Al_{0.05}PO₄, Na_{1.0}Na_{0.25}Co_{0.6}Fe_{0.1}Cu_{0.075}Mg_{0.025}Al_{0.05}PO₄, Na_{1.025}Co_{0.8}Fe_{0.1}Al_{0.025}Mg_{0.075}PO₄, Na_{1.025}Co_{0.6}Fe_{0.05}Al_{0.12}Mg_{0.325}PO_{3.75}F_{0.25}, Na_{1.025}Co_{0.7}Fe_{0.1}Mg_{0.0025}Al_{0.04}PO_{3.75}F_{0.25}, Na_{0.75}Co_{0.5}Fe_{0.05}Mg_{0.015}Al_{0.04}PO₃F, Na_{0.75}Co_{0.5}Fe_{0.025}Cu_{0.025}Be_{0.015}Al_{0.04}PO₃F, Na_{0.75}Co_{0.5}Fe_{0.025}Mn_{0.025}Ca_{0.015}Al_{0.04}PO₃F, Na_{1.025}Co_{0.6}Fe_{0.05}B_{0.12}Ca_{0.0325}PO_{3.75}F_{0.25}, Na_{1.025}Co_{0.65}Fe_{0.05}Mg_{0.0125}Al_{0.1}PO_{3.75}F_{0.25}, Na_{1.025}Co_{0.65}Fe_{0.05}Mg_{0.065}Al_{0.14}PO_{3.975}F_{0.025}, Na_{1.075}Co_{0.8}Fe_{0.05}Mg_{0.025}Al_{0.05}PO_{3.975}F_{0.025}, NaCo_{0.8}Fe_{0.1}Al_{0.025}Mg_{0.05}PO_{3.975}F_{0.025}, Na_{0.25}Fe_{0.7}Al_{0.45}PO₄, NaMnAl_{0.067}(PO₄)_{0.8}(SiO₄)_{0.2}, Na_{0.95}Co_{0.9}Al_{0.05}Mg_{0.05}PO₄, Na_{0.95}Fe_{0.8}Ca_{0.15}Al_{0.05}PO₄, Na_{0.25}MnBe_{0.425}Ga_{0.3}SiO₄, NaMn_{0.6}Ca_{0.375}Al_{0.1}PO₄, Na_{0.25}Al_{0.25}Mg_{0.25}Co_{0.75}PO₄, Na_{0.55}B_{0.15}Ni_{0.75}Ba_{0.25}PO₄, Na_{1.025}Co_{0.9}Al_{0.025}Mg_{0.05}PO₄, Na_{0.95}Co_{0.9}Al_{0.05}Mg_{0.05}PO₄, Na_{0.95}Fe_{0.8}Ca_{0.15}Al_{0.05}PO₄, Na_{1.025}Co_{0.7}(Fe_{0.4}Mn_{0.6})_{0.2}Al_{0.025}, Mg_{0.05}PO₄, Na_{1.025}Co_{0.8}Fe_{0.1}Al_{0.025}Mg_{0.05}PO₄, Na_{1.025}Co_{0.9}Al_{0.025}Mg_{0.05}PO₄, Na_{1.025}Co_{0.75}Fe_{0.15}Al_{0.025}Mg_{0.025}PO₄, NaCo_{0.75}Fe_{0.15}Al_{0.025}Ca_{0.05}PO_{3.975}F_{0.025}, NaCo_{0.9}Al_{0.025}Mg_{0.05}PO_{3.975}F_{0.025}, Na_{0.75}Co_{0.625}Al_{0.25}PO_{3.75}F_{0.25}, Na_{1.075}Co_{0.8}Cu_{0.05}Mg_{0.025}Al_{0.05}PO_{3.975}F_{0.025}, Na_{1.075}Fe_{0.8}Mg_{0.075}Al_{0.05}PO_{3.975}F_{0.025}, Na_{1.075}Co_{0.8}Mg_{0.075}Al_{0.05}PO_{3.975}F_{0.025}, Na_{1.025}Co_{0.8}Mg_{0.1}Al_{0.05}PO_{3.975}F_{0.025}, NaCo_{0.7}Fe_{0.2}Al_{0.025}Mg_{0.05}PO_{3.975}F_{0.025}, Na₂Fe_{0.8}Mg_{0.2}PO₄F; Na₂Fe_{0.5}Co_{0.5}PO₄F; Na₃CoPO₄F_{2;} KFe(PO₃F)F; Na₂Co(PO₃F)Br₂; Na₂Fe(PO₃F₂)F; Na₂FePO₄Cl; Na₂MnPO₄OH; Na₂CoPO₄F; Na₂Fe_{0.5}Co_{0.5}PO₄F; Na₂Fe_{0.9}Mg_{0.1}PO₄F; Na₂Fe_{0.8}Mg_{0.2}PO₄F; Na_{1.25}Fe_{0.9}Mg_{0.1}PO₄F_{0.25}; Na₂MnPO₄F; Na₂CoPO₄F; K₂Fe_{0.9}Mg_{0.1}P_{0.5}As_{0.5}O₄F; Na₂MnSbO₄OH; Na₂Fe_{0.6}Co_{0.4}SbO₄Br; Na₃CoAsO₄F_{2;} NaFe(AsO₃F)Cl; Na₂Co(As_{0.5}Sb_{0.5}O₃F)F_{2;} K₂Fe(AsO₃F₂)F; Na₂NiSbO₄F; Na₂FeAsO₄OH; Na₄Mn₂(PO₄)₃F; Na₄FeMn(PO₄)₃OH; Na₄FeV(PO₄)₃Br; Na₃VAl(PO₄)₃F; K₃VAl(PO₄)₃Cl; Na₂KTiFe(PO₄)₃F; Na₄Ti₂(PO₄)₃Br; Na₃V₂(PO₄)₃F_{2;} Na₆FeMg(PO₄)₃OH; Na₄Mn₂(AsO₄)₃F; K₄FeMn(AsO₄)₃OH; Na₄FeV(P_{0.5}Sb_{0.5}O₄)₃Br; Na₂KAlV(AsO₄)₃F; K₃VAl(SbO₄)₃Cl; Na₃TiV(SbO₄)₃F; Na₂FeMn(P_{0.5}As_{0.5}O₃F)₃; Na₄Ti₂(PO₄)₃F; Na_{3.25}V₂(PO₄)₃F_{0.25;} Na₄Fe₂(PO₄)₃F_{0.75;} Na_{6.5}Fe₂(PO₄)₃(OH)Cl_{0.5;} K₈Ti₂(PO₄)₃F₃Br₂; K₈Ti₂(PO₄)₃F₅; Na₄Ti₂(PO₄)₃F; Na_{2.25}V₂(PO₄)₃F_{0.5}Cl_{0.75}; K_{3.25}Mn₂(PO₄)₃OH_{0.25}; Na_{2.25}KTiV(PO₄)₃(OH)_{1.25}Cl; Na₈Ti₂(PO₄)₃F₃Cl₂; Na₇Fe₂(PO₄)₃F₂; Na₈FeMg(PO₄)₃F_{2.25}Cl_{0.75}; Na_{5.5}TiMn(PO₄)₃(OH)₂Cl_{0.5}; Na₃K_{4.5}MnCa(PO₄)₃(OH)_{1.5}Br; K₉FeBa(PO₄)₃F₂Cl_{2;} Na₇Ti₂(SiO₄)₂(PO₄)F₂; Na₈Mn₂(SiO₄)₂(PO₄)F₂Cl; Na₃K₂V₂(SiO₄)₂(PO₄)(OH)Cl; Na₄Ti₂(SiO₄)₂(PO₄)(OH); Na₃KV₂(SiO₄)₂(PO₄)F; Na₅TiFe(PO₄)₃F; Na₄K₂VMg(PO₄)₃FCl; Na₄NaAlNi(PO₄)₃(OH); Na₄K₃FeMg(PO₄)₃F_{2;} Na₄K₂CrMn(PO₄)₃(OH)Br; Na₅TiCa(PO₄)₃F; Na₄Ti_{0.75}Fe_{1.5}(PO₄)₃F; Na₄SnFe(PO₄)₃(OH); Na₃NaGe_{0.5}Ni₂(PO₄)₃(OH); Na₃K₂VCo(PO₄)₃(OH)Cl; Na₄Na₂MnCa(PO₄)₃F(OH); Na₄KTiFe(PO₄)₃F; Na₇FeCo(SiO₄)₂(PO₄)F; Na₆TiV(SiO₄)₂(PO₄)F; K_{5.5}CrMn(SiO₄)₂(PO₄)Cl_{0.5}; Na_{5.5}V₂(SiO₄)₂(PO₄)(OH)_{0.5}; Na_{5.25}FeMn(SiO₄)₂(PO₄)Br_{0.25}; Na_{6.5}VCo(SiO₄)_{2.5}(PO₄)_{0.5}F; Na_{7.25}V₂(SiO₄)_{2.25}(PO₄)_{0.75}F₂; Na₅VTi(SiO₄)₃F_{0.5}Cl_{0.5}; Na₂K_{2.5}ZrV(SiO₄)₃F_{0.5}; Na₄K₂MnV(SiO₄)₃(OH)₂; Na₃Na₃KTi₂(SiO₄)₃F; K₆V₂(SiO₄)₃(OH)Br; Na₈FeMn(SiO₄)₃F₂; Na_{7.5}MnNi(SiO₄)₃(OH)_{1.5}; Na₅K₂TiV(SiO₄)₃(OH)_{0.5}Cl_{0.5}; K₉VCr(SiO₄)₃F₂Cl; Na₈V₂(SiO₄)₃FBr; Na₄FeMg(SO₄)₃F₂; Na₂KNiCo(SO₄)₃(OH); Na₅MnCa(SO₄)₃F₂Cl; Na₄CoBa(SO₄)₃FBr; Na_{2.5}K_{0.5}FeZn(SO₄)₃F; Na₃MgFe(SO₄)₃F₂; Na₃CaV(SO₄)₃FCl; Na₄NiMn(SO₄)₃(OH)₂; Na₂KBaFe(SO₄)₃F, Na₂KCuV(SO₄)₃(OH)Br; Na_{1.5}CoPO₄F_{0.5}; Na_{1.25}CoPO₄F_{0.25}; Na_{1.75}FePO₄F_{0.75}; Na_{1.66}MnPO₄F_{0.66}; Na_{1.5}Co_{0.75}Ca_{0.25}PO₄F_{0.5}; Na_{1.75}Co_{0.8}Mn_{0.2}PO₄F_{0.75}; Na_{1.25}Fe_{0.75}Mg_{0.25}PO₄F_{0.25}; Na_{1.66}Co_{0.6}Zn_{0.4}PO₄F_{0.66}; KMn₂SiO₄Cl; Na₂VSiO₄(OH)₂; Na₃CoGeO₄F; NaMnSO₄F; NaFe_{0.9}Mg_{0.1}SO₄Cl; NaFeSO₄F; NaMnSO₄OH; KMnSO₄F; Na_{1.75}Mn_{0.8}Mg_{0.2}PO₄F_{0.75}; Na₃FeZn(PO₄)F_{2;} Na_{0.5}V_{0.75}Mg_{0.5}(PO₄)F_{0.75}; Na₃V_{0.5}Al_{0.5}(PO₄)F_{3.5}; Na_{0.75}VCa(PO₄)F_{1.75;} Na₄CuBa(PO₄)F₄; Na_{0.5}V_{0.5}Ca(PO₄)(OH)_{1.5}; Na_{1.5}FeMg(PO₄)(OH)Cl; NaFeCoCa(PO₄)(OH)₃F; Na₃CoBa(PO₄)(OH)₂Br₂; Na_{0.75}Mn_{1.5}Al(PO₄)(OH)_{3.75}; Na₂Co_{0.75}Mg_{0.25}(PO₄)F; Na₂Co_{0.8}Mg_{0.2}(PO₄)F; NaKCo_{0.5}Mg_{0.5}(PO₄)F; Na_{1.5}K_{0.5}Fe_{0.75}Mg_{0.25}(PO₄)F; Na_{1.5}K_{0.5}V_{0.5}Zn_{0.5}(PO₄)F₂; Na₆Fe₂Mg(PS₄)₃(OH₂)Cl; Na₄Mn_{1.5}Co_{0.5}(PO₃F)₃(OH)_{3.5}; K₈FeMg(PO₃F)₃F₃Cl₃a₅Fe₂Mg(SO₄)₃Cl₅; NaTi₂(SO₄)₃Cl, NaMn₂(SO₄)₃F, Na₃Ni₂(SO₄)₃Cl, Na₃Co₂(SO₄)₃F, Na₃Fe₂(SO₄)₃Br, Na₃Mn₂(SO₄)₃F, Na₃MnFe(SO₄)₃F, Na₃NiCo(SO₄)₃Cl; NaMnSO₄F; NaFeSO₄Cl; NaNiSO₄F; NaCoSO₄Cl; NaMn₁₋ₓFeₓSO₄F, NaFe₁₋ₓMgₓSO₄F; Na₇ZrMn(SiO₄)₃F; Na₇MnCo(SiO₄)₃F; Na₇MnNi(SiO₄)₃F; Na₇VAl(SiO₄)₃F; Na₅MnCo(PO₄)₂(SiO₄)F; Na₄VAl(PO₄)₂(SiO₄)F; Na₄MnV(PO₄)₂(SiO₄)F; Na₄VFe(PO₄)₂(SiO₄)F; Na_{0.6}VPO₄F_{0.6}; Na_{0.8}VPO₄F_{0.8}; NaVPO₄F; Na₃V₂(PO₄)₂F₃; NaVPO₄Cl; NaVPO₄OH; NaVPO₄F; Na₃V₂(PO₄)₂F₃; NaV_{0.9}Al_{0.1}PO₄F; NaFePO₄F; NaTiPO₄F; NaCrPO₄F; NaFePO₄; NaCoPO₄, NaMnPO₄; NaFe_{0.9}Mg_{0.1}PO₄; NaFe_{0.8}Mg_{0.2}PO₄; NaFe_{0.95}Mg_{0.05}PO₄; NaFe_{0.9}Ca_{0.1}PO₄; NaFe_{0.8}Ca_{0.2}PO₄; NaFe_{0.8}Zn_{0.2}PO₄; NaMn_{0.8}Fe_{0.2}PO₄; NaMn_{0.9}Fe_{0.8}PO₄; Na₃V₂(PO₄)₃; Na₃Fe₂(PO₄)₃; Na₃Mn₂(PO₄)₃; Na₃FeTi(PO₄)₃; Na₃CoMn(PO₄)₃; Na₃FeV(PO₄)₃; Na₃VTi(PO₄)₃; Na₃FeCr(PO₄)₃; Na₃FeMo(PO₄)₃; Na₃FeNi(PO₄)₃; Na₃FeMn(PO₄)₃; Na₃FeAl(PO₄)₃; Na₃FeCo(PO₄)₃; Na₃Ti₂(PO₄)₃; Na₃TiCr(PO₄)₃; Na₃TiMn(PO₄)₃; Na₃TiMo(PO₄)₃; Na₃TiCo(PO₄)₃; Na₃TiAl(PO₄)₃; Na₃TiNi(PO₄)₃; Na₃ZrMnSiP₂O₁₂; Na₃V₂SiP₂O₁₂; Na₃MnVSiP₂O₁₂; Na₃TiVSiP₂O₁₂; Na₃TiCrSiP₂O₁₂; Na_{3.5}AlVSi_{0.5}P_{2.5}O₁₂; Na_{3.5}V2Si_{0.5}P_{2.5}O₁₂; Na_{2.5}AlCrSi_{0.5}P_{2.5}O₁2; Na_{2.5}V₂P₃O_{11.5}F_{0.5}; Na₂V₂P₃O₁₁F; Na_{2.5}VMnP₃O_{11.5}F_{0.5}; Na₂V_{0.5}Fe_{1.5}P₃O₁₁F; Na₃V_{0.5}V_{1.5}P₃O_{11.5}F_{0.5}; Na₃V₂P₃O₁₁F; Na₃Mn_{0.5}V_{1.5}P₃O₁₁F_{0.5}; NaCo_{0.8}Fe_{0.1}Ti_{0.025}Mg_{0.05}PO₄; Na_{1.025}Co_{0.8}Fe_{0.1}Ti_{0.025}Al_{0.025}PO₄; Na_{1.025}Co_{0.8}Fe_{0.1}Ti_{0.025}Mg_{0.025}PO_{3.975}F_{0.025}; NaCo_{0.825}Fe_{0.1}Ti_{0.025}Mg_{0.025}PO₄; NaCo_{0.85}Fe_{0.075}Ti_{0.025}Mg_{0.025}PO₄; NaCo_{0.8}Fe_{0.1}Ti_{0.025}Al_{0.025}Mg_{0.025}PO₄, Na_{1.025}Co_{0.8}Fe_{0.1}Ti_{0.025}Mg_{0.05}PO₄, Na_{1.025}Co_{0.8}Fe_{0.1}Ti_{0.025}Al_{0.025}Mg_{0.025}PO₄, NaCo_{0.8}Fe_{0.1}Ti_{0.05}Mg_{0.05}PO₄, as well as lithium analogues of the same.

Preferred active materials of this subembodiment include NaFePO₄; NaCoPO₄, NaMnPO₄; NaMn_{0.8}Fe_{0.2}PO₄; NaMn_{0.9}Fe_{0.8}PO₄; NaFe_{0.9}Mg_{0.1}PO₄; NaFe_{0.8}Mg_{0.2}PO₄; NaFe_{0.95}Mg_{0.05}PO₄; Na_{1.025}Co_{0.85}Fe_{0.05}Al_{0.025}Mg_{0.05}PO₄, Na_{1.025}Co_{0.80}Fe_{0.10}Al_{0.025}Mg_{0.05}PO₄, Na_{1.025}Co_{0.75}Fe_{0.15}Al_{0.025}Mg_{0.05}PO₄, Na_{1.025}Co_{0.7}(Fe_{0.4}Mn_{0.6})_{0.2}Al_{0.025}Mg_{0.05}PO₄, NaCo_{0.8}Fe_{0.1}Al_{0.025}Ca_{0.05}PO_{3.975}F_{0.025}, NaCo_{0.8}Fe_{0.1}Al_{0.025}Mg_{0.05}PO_{3.975}F_{0.025}, NaCo_{0.8}Fe_{0.1}Ti_{0.025}Mg_{0.05}PO₄; Na_{1.025}Co_{0.8}Fe_{0.1}Ti_{0.025}Al_{0.025}PO₄; Na_{1.025}Co_{0.8}Fe_{0.1}Ti_{0.025}Mg_{0.025}PO_{3.975}F_{0.025}; NaCo_{0.825}Fe_{0.1}Ti_{0.025}Mg_{0.025}PO₄; NaCo_{0.85}Fe_{0.075}Ti_{0.025}Mg_{0.025}PO₄. A particularly preferred active materials are NaFePO₄ and Na₃V₂(PO₄)₃.

In another particular subembodiment, the positive electrode film 26 contains an electrode active material represented by the general formula (III):
AₐM_{b}Oₑ, (III)

wherein:
(i) moieties A and M are as described herein above, wherein 0<a≦6 and 1≦b≦6; and
(iii) 0<e≦15;

wherein M, a, b and e are selected so as to maintain electroneutrality of the material in its nascent or as-synthesized state.

Preferably 2≦e≦13, and even more preferably 2≦e≦8.

A preferred electrode active material of the present subembodiment comprises a compound of the formula (IV):
AₐNiₜCoᵤM⁴ᵥO₂, (IV)
wherein 0<(t+u)≦1, and 0≦t<1. In one embodiment t=(1−u), where t=0. In another embodiment t=(1−u−v), wherein v>0. M⁴ is at least one metal selected from Group 2, 12, 13, or 14 of the Periodic Table, more preferably M⁴ is selected from the group consisting of Mg, Ca, Al, and mixtures thereof.

Methods of making the electrode active materials described by general formulas (III) and (IV) are well known in the art, and are described in: U.S. Pat. No. 5,225,297 to Garcia-Alvarado et al., issued Jul. 6, 1993; U.S. Pat. No. 5,340,671 to Koksbang, issued Aug. 23, 1994; U.S. Pat. No. 5,366,830 to Koksbang, issued Nov. 22, 1994; U.S. Pat. No. 5,587,133 to Amatucci et al., issued Dec. 24, 1996; U.S. Pat. No. 5,630,993 to Amatucci et al., issued May 20, 1997; U.S. Pat. No. 5,670,277 to Barker et al., issued Sep. 23, 1997; U.S. Pat. No. 5,693,435 to Amatucci et al., issued Dec. 2, 1997; U.S. Pat. No. 5,698,338 to Barker et al., issued Dec. 16, 1997; and U.S. Pat. No. 5,744,265 to Barker et al., issued Apr. 28, 1998.

Non-limiting examples of active materials of this subembodiment and represented by general formulas (I), (III) and (IV) include the following: NaMn₂O₄, NaNi_{0.75}Al_{0.25}O₂, Na₂CuO₂, γ-NaV₂O₅,LiCo_{0.5}Ni_{0.5}O₂, NaCoO₂, NaNiO₂, NaNiCoO₂, NaNi_{0.75}Co_{0.25}O₂, NaNi_{0.8}Co_{0.2}O₂, NaNi_{0.6}Co_{0.4}O₂, NaMnO₂, NaMoO₂, NaNi_{0.8}Co_{0.15}Al_{0.05}O₂, NaFeO₃, α-NaFe₅O₈, β-NaFe₅O₈, Na₂Fe₃O₄, NaFe₂O₃, NaNi_{0.6}Co_{0.2}Al_{0.2}O₂, NaNi_{0.8}Co_{0.15}Mg_{0.05}O₂, NaNi_{0.8}Co_{0.15}O₂, NaNi_{0.8}Co_{0.15}Al_{0.05}O₂, NaCr_{0.8}Co_{0.15}Al_{0.05}O₂, Na_{0.5}Na_{0.5}CoO₂, NaNi_{0.6}Co_{0.4}O₂, KNi_{0.75}Co_{0.25}O₂, NaFe_{0.75}Co_{0.25}O₂, NaCu_{0.8}Co_{0.2}O₂, NaTi_{0.9}Ni_{0.1}O₂, NaV_{0.8}Co_{0.2}O2, Na₃V₂Co_{0.5}Al_{0.5}O₅, Na₂NaVNi_{0.5}Mg_{0.5}O₅, Na₅CrFe_{1.5}CaO₇, NaCrO₂, NaVO₂, NaTiO₂, NaVO₂, NaTiO₂, Na₂FeV₂O₅, Na₅Ni_{2.5}Co₃O₈; Na₆V₂Fe_{1.5}CaO₉, potassium (K) and lithium (Li) analogs thereof, and mixtures thereof. Preferred materials include NaNiO₂, NaCoO₂, NaNi₁₋ₓCoₓO₂, γ-NaV₂O₅, and Na₂CuO₂.

In another particular subembodiment, the positive electrode film 26 contains an electrode active material represented by the general formula (V):
AₐMn_{b}O₄, (V)
(herein “modified manganese oxide”) having an inner and an outer region, wherein the inner region comprises a cubic spinel manganese oxide, and the outer region is enriched with Mn⁺⁴ relative to the inner region, moiety A is as described herein above, and a and b are selected so as to maintain electroneutrality of the material in its nascent or as-synthesized state.

Preferably 0<a≦2.0, more preferably 0.8≦a≦1.5, and even more preferably 0.8≦a≦1.2.

In a preferred embodiment, such modified manganese oxide active materials are characterized as particles having a core or bulk structure of cubic spinel manganese oxide and a surface region which is enriched in Mn⁺⁴ relative to the bulk. X-ray diffraction data and x-ray photoelectron spectroscopy data are consistent with the structure of the stabilized manganese oxide being a central bulk of cubic spinel lithium manganese oxide with a surface layer or region comprising A₂MnO₃, where A is an alkali metal.

The mixture preferably contains less than 50% by weight of the alkali metal compound, preferably less than about 20%. The mixture contains at least about 0.1% by weight of the alkali metal compound, and preferably 1% by weight or more. In a preferred embodiment, the mixture contains from about 0.1% to about 20%, preferably from about 0.1% to about 10%, and more preferably from about 0.4% to about 6% by weight of the alkali metal compound.

The alkali metal compound is a compound of lithium, sodium, potassium, rubidium or cesium. The alkali metal compound serves as a source of alkali metal ion in particulate form. Preferred alkali metal compounds are sodium compounds and lithium compounds. Examples of compounds include, without limitation, carbonates, metal oxides, hydroxides, sulfates, aluminates, phosphates and silicates. Examples of lithium compounds thus include, without limitation, lithium carbonates, lithium metal oxides, lithium mixed metal oxides, lithium hydroxides, lithium aluminates, and lithium silicates, while analogous sodium compounds are also preferred. A preferred lithium compound is lithium carbonate. Sodium carbonate and sodium hydroxide are preferred sodium compounds. The modified manganese oxide is preferably characterized by reduced surface area and increased alkali metal content compared to an unmodified spinel lithium manganese oxide. In one alternative, essentially all of a lithium or sodium compound is decomposed or reacted with the lithium manganese oxide.

In one aspect, the decomposition product is a reaction product of the LMO particles and the alkali metal compound. For the case where the alkali metal is lithium, a lithium-rich spinel is prepared. A preferred electrode active material embodiment comprises a compound of the formula A₁₊ₚMn₂₋ₚO₄, where 0≦p<0.2. Preferably p is greater than or equal to about 0.081.

In many embodiments, the modified manganese oxide material of the invention is red in color. Without being bound by theory, the red color may be due to a deposit or nucleation of Li₂MnO₃ (or Na₂MnO₃, which is also red in color) at the surface or at the grain boundaries. Without being bound by theory, one way to envision the formation of the “red” modified manganese oxide is as follows. Mn⁺³ at the surface of a cubic spinel lithiated manganese oxide particle loses an electron to combine with added alkali metal from the alkali metal compound. Advantageously, the alkali metal compound is lithium carbonate. Thus, the cubic spinel lithiated manganese oxide becomes enriched in lithium. Charge balance is maintained by combination with oxygen from the available atmosphere, air, during the solid state synthesis. The oxidation of Mn⁺³ to Mn⁺⁴ at the surface of the particle results in a loss of available capacity and a contraction of the unit cell. Thus a surface region of the particle relatively enhanced in Mn⁺⁴ forms during the reaction of the cubic spinel lithiated manganese oxide with the lithium compound in air or in the presence of oxygen. At least in the early stages of the reaction, a surface layer or coating of Li₂MnO₃ is formed on the surface of the particle. It is believed that formation of the red colored Li₂MnO₃ (or Na₂MnO₃) at the surface of the particle is responsible for the red color observed in some samples of the treated LMO of the invention.

Methods of making the electrode active materials described by general formula (V) are well known in the art, and are described in: U.S. Pat. No. 5,869,207 to Barker et al., issued Feb. 9, 1999; U.S. Pat. No. 6,183,718 to Barker et al., issued Feb. 6, 2001; U.S. Pat. No. 6,869,547 to Barker et al., issued Mar. 22, 2005; and U.S. Pat. No. 6,596,435 to Barker et al., issued Jul. 22, 2003.

In another particular subembodiment, the positive electrode film 26 contains an electrode active material represented by the general formula (VI):
Aₐ(M′O)_{c}XO₄Z_{f}, (VI)

wherein:

(i) moieties A, M′ and Z are as described herein above, wherein 0<a≦9, 0<c≦1, and 0≦f≦4, and
(ii) X is selected from the group consisting of P, As, Sb, Si, Ge, V, S, and mixtures thereof;

wherein A, M′, X, a, c, and f are selected so as to maintain electroneutrality of the material in its nascent or as-synthesized state.

In one particular subembodiment, moiety (M′O) of general formula (VI) is a 2+ ion containing a metal (M′) in the 4+ oxidation state. Preferably, M′ is vanadium (V), and XY₄═PO₄.

Methods of making the electrode active materials described by general formula (VI) are well known in the art, and are described in U.S. Publication No. 2002/0262571 to Barker et al., published Dec. 30, 2004.

Non-limiting examples of active materials of this subembodiment and represented by general formulas (I) and (VI) include the following: NaVOPO₄, Na(VO)_{0.75}Mn_{0.25}PO₄, NaVOPO₄, NaVOPO₄, Na(VO)_{0.5}Al_{0.5}PO₄, Na(VO)_{0.75}Fe_{0.25}PO₄, Na_{0.5}Na_{0.5}VOPO₄, Na(VO)_{0.75}Co_{0.25}PO₄, Na(VO)_{0.75}Mo_{0.25}PO₄, and NaVOSO₄ Particularly preferred are NaVOPO₄ and Na(VO)_{0.75}Mn_{0.25}PO₄.

In another particular subembodiment, the positive electrode film 26 contains an electrode active material represented by the general formula (VII):
AₐM_{b}WO₄, (VII)

wherein:
(i) moieties A and M are as described herein above, wherein 0<a≦2 and 0<b≦1; and
(ii) W is selected from the group consisting of Hf, Ti, Zr, and mixtures thereof;

wherein A, M, W, a and b are selected so as to maintain electroneutrality of the material in its nascent or as-synthesized state.

In one particular subembodiment, moiety M is selected from the group consisting of Ni, Co, Fe, Mn, V, Cr and mixtures thereof.

Methods of making the electrode active materials described by general formula (VI) are well known in the art, and are described in U.S. Pat. No. 6,103,419 to Saidi et al., issued Aug. 15, 2000.

Non-limiting examples of active materials of this subembodiment and represented by general formulas (I) and (VII) include the following: Na₂FeTiO₄, Na₂FeZrO₄, Na₂VTiO₄, Na₂VZrO₄, Na₂NiTiO₄, and Na₂NiZrO₄.

The following non-limiting examples illustrate the compositions and methods of the present invention.

### EXAMPLE 1

An electrode active material of formula Na_{1.025}Co_{0.9}Al_{0.025}Mg_{0.05}PO₄, is made as follows. The following sources of Li, Co, Al, Mg, and phosphate are provided containing the respective elements in a molar ratio of 1.025:0.9:0.025:0.05:1.

| | |
|---|---|
| 0.05125 moles Na₂CO₃ (mol. wt. 105.99 g/mol) | 7.7 g |
| 0.03 moles Co₃O₄ (240.8 g/mol) | 7.2 g |
| 0.0025 moles Al (OH)₃ (78 g/mol) | 0.195 g |
| 0.005 moles Mg(OH)₂ (58 g/mol) | 0.29 g |
| 0.1 moles (NH₄)₂HPO₄ (132 g/mol) | 13.2 g |
| 0.2 moles elemental carbon (12 g/mol) (>100% excess) | 2.4 g |

The above starting materials are combined and ball milled to mix the particles. Thereafter, the particle mixture is pelletized. The pelletized mixture is heated for 4-20 hours at 750° C. in an oven in an argon atmosphere. The sample is removed from the oven and cooled. An x-ray diffraction pattern shows that the material has an olivine type crystal structure. An electrode is made with 80% of the active material, 10% of Super P conductive carbon, and 10% poly vinylidene difluoride. A cell with that electrode as cathode and carbon intercalation anode is constructed with an electrolyte comprising 1 M LiPF₆ dissolved in 2:1 by weight mixture of ethylene carbonate:dimethyl carbonate

### EXAMPLE 2

An electrode active material of the formula Na_{1.025}Co_{0.8}Fe_{0.1}Al_{0.025}Mg_{0.05}PO₄ is made as follows. The following sources of Na, Co, Fe, Al, Mg, and phosphate are provided containing the respective elements in a molar ratio of 1.025:0.8:0.1:0.025:0.05:1.

| | |
|---|---|
| 0.05125 moles Na₂CO₃ (mol. wt. 105.99 g/mol) | 7.7 g |
| 0.02667 moles Co₃ O₄ (240.8 g/mol) | 6.42 g |
| 0.005 moles Fe₂ O₃ (159.7 g/mol) | 0.8 g |
| 0.0025 moles Al (OH)₃ (78 g/mol) | 0.195 g |
| 0.005 moles Mg(OH)₂ (58 g/mol) | 0.29 g |
| 0.1 moles (NH₄)₂HPO₄ (132 g/mol) | 13.2 g |
| 0.2 moles elemental carbon (12 g/mol) (>100% excess) | 2.4 g |

The above starting materials are combined and ball milled to mix the particles. Thereafter, the particle mixture is pelletized. The pelletized mixture is heated for 4-20 hours at 750° C. in an oven in an argon atmosphere. The sample is removed from the oven and cooled. An x-ray diffraction pattern shows that the material has an olivine type crystal structure. An electrode is made with 80% of the active material, 10% of Super P conductive carbon, and 10% poly vinylidene difluoride. A cell with that electrode as cathode and a carbon intercalation anode is constructed with an electrolyte comprising 1 M LiPF₆ dissolved in a 3:1 by weight mixture of γ-butyrolactone:ethylene carbonate.

### EXAMPLE3

An electrode active material comprising Na₂NiPO₄F, representative of the formula Na₁₊ₓNiPO₄Fₓ, is made as follows. First, a NaNiPO₄ precursor is made according to the following reaction scheme.
0.5 Na₂CO₃+0.334 Ni₃(PO₄)₂.7H₂O+0.334 (NH₄)₂HPO₄→LiNiPO₄+2.833 H₂O+0.667 NH₃+0.5 CO₂
A mixture of 52.995 g (0.5 mol) of Na₂CO₃, 164.01 (0.334 mol) of Ni₃(PO₄)₂.7H₂O, and 44.11 g (0.334 mol) of (NH₄)₂HPO₄ is made, using a and pestle. The mixture is pelletized, and transferred to a box oven equipped with a atmospheric air gas flow. The mixture is heated, at a ramp rate of about 2° C. minute to an ultimate temperature of about 800° C., and maintained at this temperature for 16 hours. The product is then cooled to ambient temperature (about 21° C.).

Na₁₊ₓNiPO₄Fₓ is then made from the NaNiPO₄ precursor. In the Example that follows, x is 1.0, so that the active material produced is represented by the formula Na₂NiPO₄F. The material is made according to the following reaction scheme.
NaNiPO₄+x NaF [symbol] Na₁₊ₓNiPO₄Fₓ
For x equal to 1.0, a mixture of 1 mol LiNiPO₄ and 1 mol NaF is made, using a mortar and pestle. The mixture is pelletized, and transferred to a temperature-controlled tube furnace equipped with a argon gas flow. The mixture is heated at a ramp rate of about 2°/minute to an ultimate temperature of about 850° C. The product is then cooled to ambient temperature (about 20° C.). An electrode is made with 80% of the active material, 10% of Super P conductive carbon, and 10% poly vinylidene difluoride. A cell with that electrode as cathode and a carbon intercalation anode is constructed with an electrolyte comprising 1 M LiPF₆ dissolved in a 3:1 by weight mixture of γ-butyrolactone:ethylene carbonate.

### EXAMPLE 4

An electrode active material comprising Na_{1.2}VPO₄F_{1.2} is made as follows. In a first step, a metal phosphate is made by carbothermal reduction of a metal oxide, here exemplified by vanadium pentoxide. The overall reaction scheme of the carbothermal reduction is as follows.
0.5V₂O₅+NH₄H₂PO₄+C [symbol] VPO₄+NH₃+1.5H₂O+CO
9.1 grams of V₂O₅, 11.5 grams of NH₄H₂PO₄ and 1.2 grams of carbon (10% excess) are used. The precursors are premixed using a mortar and pestle and then pelletized. The pellet is transferred to an oven equipped with a flowing argon atmosphere. The sample is heated at a ramp rate of 2° per minute to an ultimate temperature of 300° C. and maintained at this temperature for three hours. The sample is cooled to room temperature, removed from the oven, recovered, re-mixed and repelletized. The pellet is transferred to a furnace with an argon atmosphere. The sample is heated at a ramp rate of 2° per minute to an ultimate temperature 750° C. and maintained at this temperature for 8 hours.

In a second step, the vanadium phosphate made in the first step is reacted with an alkali metal halide, exemplified by sodium fluoride, according to the following reaction scheme.
xNaF+VPO₄ [symbol] NaₓVPO₄Fₓ
14.6 grams of VPO₄ and 4.2 grams of NaF are used. The precursors are pre-mixed using a mortar and pestle and then pelletized. The pellet is transferred to an oven equipped with a flowing argon atmosphere, the sample is heated at a ramp rate of 2° per minute to an ultimate temperature of 750° C. and maintained at this temperature for an hour. The sample is cooled and removed from the furnace.

To make Na_{1.2}VPO₄F_{1.2}, the reaction is repeated with a 20% mass excess of sodium fluoride over the previous reaction. The precursors are pre-mixed using a mortar and pestle and pelletized as before. The sample is heated to an ultimate temperature of 700° C. and maintained at this temperature for 15 minutes. The sample is cooled and removed from the oven. There is only a small weight loss during reaction, indicating almost full incorporation of the NaF. To make an active material of formula Na_{1.5}VPO₄F_{1.5} the reaction is repeated with an approximate 50% mass excess of sodium fluoride over the first reaction. The sample is heated at 700° C. for 15 minutes, cooled, and removed from the oven. An electrode is made with 80% of the active material, 10% of Super P conductive carbon, and 10% poly vinylidene difluoride. A cell with that electrode as cathode and graphite as anode is constructed with an electrolyte comprising 1 M LiPF₆ dissolved in 2:1 by weight mixture of ethylene carbonate:dimethyl carbonate.

### EXAMPLE 5

An electrode active material comprising NaCoPO₄F is made according to the following reaction scheme.
0.33 Co₃O₄₊NH₄H₂PO₄+NaF+0.083 O₂ [symbol] NaCoPO₄F+NH₃+1.5H₂O

This active material is made under oxidizing conditions where the metal in the final product has a higher oxidation state than the metal in the starting material. 3 grams of Co₃O₄, 1.57 grams of NaF, and 4.31 grams of NH₄H₂PO₄ are mixed, pelletized, and heated to an ultimate temperature of 300° C. and maintained at the temperature for three hours. This sample is cooled, removed from the oven, repelletized, and returned to the oven where it is heated to an ultimate temperature of 800° C. and maintained at the temperature for eight hours. An electrode is made with 80% of the active material, 10% of Super P conductive carbon, and 10% poly vinylidene difluoride. A cell with that electrode as cathode and carbon intercalation anode is constructed with an electrolyte comprising 1 M LiPF₆ dissolved in 2:1 by weight mixture of ethylene carbonate:dimethyl carbonate.

### EXAMPLE 6

An electrode active material comprising Li_{0.1}Na_{0.9}VPO₄F is made according to the following reaction scheme.
xLiF+(1−x)NaF+VPO₄ [symbol] LiₓNa₁₋ₓVPO₄F
As an alternative to using alkaline fluorides, a reaction between VPO₄ and NH₄F and a mixture of Li₂CO₃ and Na₂CO₃ may also be used.

To make Li_{0.1}Na_{0.9}VPO₄F, 1.459 grams VPO₄, 0.026 grams of LiF, and 0.378 grams of NaF are premixed, pelletized, placed in an oven and heated to an ultimate temperature of 700° C. The temperature is maintained for fifty minutes after which the sample is cooled to room temperature and removed from the oven. To make Li_{0.95}Na_{0.05}VPO₄F, 1.459 grams of VPO₄, 0.246 grams of LiF, and 0.021 grams of NaF are mixed together and heated in an oven as in the previous step. An electrode is made with 80% of the active material, 10% of Super P conductive carbon, and 10% poly vinylidene difluoride. A cell with that electrode as cathode and carbon intercalation anode is constructed with an electrolyte comprising 1 M LiPF₆ dissolved in 2:1 by weight mixture of ethylene carbonate:dimethyl carbonate.

### EXAMPLE 7

An electrode active material comprising NaVPO₄F is made hydrothermally according to the following reaction scheme.
NaF+VPO₄ [symbol] NaVPO₄F

1.49 grams of VPO₄ and 1.42 grams of NaF are premixed with approximately 20 milliliters of deionized water, transferred and sealed in a Parr Model 4744 acid digestion bomb, which is a Teflon lined stainless steel hydrothermal reaction vessel. The bomb is placed in an oven and heated at a ramp rate of 5° per minute to an ultimate temperature of 250° C. to create an internal pressure and maintained at this temperature for forty-eight hours. The sample is slowly cooled to room temperature and removed from the furnace for analysis. The product sample is washed repeatedly with deionized water to remove unreacted impurities. Then the sample is dried in an oven equipped with argon gas flow at 250° C. for one hour. An electrode is made with 80% of the active material, 10% of Super P conductive carbon, and 10% poly vinylidene difluoride. A cell with that electrode as cathode and carbon intercalation anode is constructed with an electrolyte comprising 1 M LiPF₆ dissolved in 2:1 by weight mixture of ethylene carbonate:dimethyl carbonate.

### EXAMPLE 8

An electrode active material of formula NaVPO₄OH is made according to the following alternative reaction scheme.
NaOH+VPO₄ [symbol] NaVPO₄OH

In this Example, the reaction of the Example 14 is repeated, except that an appropriate molar amount of sodium hydroxide is used instead of sodium fluoride. The reaction is carried out hydrothermally as in Example 14. The hydroxyl group is incorporated into the active material at the relatively low temperature of reaction. An electrode is made with 80% of the active material, 10% of Super P conductive carbon, and 10% poly vinylidene difluoride. A cell with that electrode as cathode and carbon intercalation anode is constructed with an electrolyte comprising 1 M LiPF₆ dissolved in 2:1 by weight mixture of ethylene carbonate:dimethyl carbonate.

### EXAMPLE 9

An electrode active material comprising NaVPO₄F is made according to the following reaction scheme,
0.5Na₂CO₃+NH₄F+VPO₄ [symbol] NaVPO₄F+NH₃+0.5CO₂ +0.5H₂O

1.23 grams of VPO₄, 0.31 grams of NH₄F, and 0.45 grams Na₂CO₃ are premixed with approximately 20 milliliters of deionized water and transferred and sealed in a Parr Model 4744 acid digestion bomb, which is a Teflon lined stainless steel reaction vessel. The bomb is placed in an oven and heated to an ultimate temperature of 250° C. and maintained at this temperature for forty-eight hours. The sample is cooled to room temperature and removed for analysis. The sample is washed repeatedly with the deionized water to remove unreacted impurities and thereafter is dried in an argon atmosphere at 250° C. for an hour. An electrode is made with 80% of the active material, 10% of Super P conductive carbon, and 10% poly vinylidene difluoride. A cell with that electrode as cathode and carbon intercalation anode is constructed with an electrolyte comprising 1 M LiPF₆ dissolved in 2:1 by weight mixture of ethylene carbonate:dimethyl carbonate.

### EXAMPLE 10

An electrode active material comprising Li₄Fe₂(PO₄)₃F, representative of materials of the general formula AₐM_{b}(PO₄)₃Z_{d}, is made according to the following reaction scheme.
2Li₂CO₃+Fe₂O₃+3NH₄H₂(PO₄)+NH₄F [symbol] Li₄Fe₂(PO₄)₃F+2CO₂+4NH₃+5H₂O

Here, M₂O₃ represents a +3 metal oxide or mixture of +3 metal oxides. Instead of 2 lithium carbonates, a mixture of lithium sodium and potassium carbonates totaling two moles may be used to prepare an analogous compound having lithium, sodium and potassium as alkali metals. The starting material alkali metal carbonate, the metal or mixed metal +3 oxidation state oxides, the ammonium dihydrogen phosphate, and the ammonium fluoride are combined in stoichiometric ratios indicated in the form of powders, and the powders are mixed and pelletized as in the previous examples. The pellet is transferred to an oven and is heated up to an ultimate temperature of about 800° C. and maintained at that temperature for 8 hours. The reaction mixture is then cooled and removed from the oven. An electrode is made with 80% of the active material, 10% of Super P conductive carbon, and 10% poly vinylidene difluoride. A cell with that electrode as cathode and carbon intercalation anode is constructed with an electrolyte comprising 1 M LiPF₆ dissolved in 2:1 by weight mixture of ethylene carbonate:dimethyl carbonate.

### EXAMPLE 11

An electrode active material comprising Na₂Li₂M₂(PO₄)₃F is made according to the following reaction scheme.
Li₂CO₃+Na₂CO₃+2MPO₄+NH₄H₂PO₄+NH₄F [symbol] Na₂Li₂M₂(PO₄)₃F+2CO₂+2NH₃+2H₂O

The starting materials are combined in the stoichiometric ratios indicated and are reacted according to the general procedure of Example 10. Here, MPO₄ represents a metal +3 phosphate or mixture of metal +3 phosphates. An electrode is made with 80% of the active material, 10% of Super P conductive carbon, and 10% poly vinylidene difluoride. A cell with that electrode as cathode and carbon intercalation anode is constructed with an electrolyte comprising 1 M LiPF₆ dissolved in 2:1 by weight mixture of ethylene carbonate:dimethyl carbonate.

### EXAMPLE 12

An electrode active material comprising Na₃V₂(PO₄)₂F₃ is made as follows. First, a VPO₄ precursor is made according to the following reaction scheme.
V₂O₅+2 (NH₄)₂HPO₄+C→VPO₄
A mixture of 18.2 g (0.1 mol) of V₂O₅, 26.4 g (0.2 mol) of (NH₄)₂HPO₄, and 2.4 g (0.2 mol) of elemental carbon is made, using a mortar and pestle. The mixture is pelletized, and transferred to a box oven equipped with an argon gas flow. The mixture is heated to a temperature of about 350° C., and maintained at this temperature for 3 hours. The mixture is then heated to a temperature of about 750° C., and maintained at this temperature for 8 hours. The product is then cooled to ambient temperature (about 21° C.).

Na₃V₂(PO₄)₂F₃ is then made from the VPO₄ precursor. The material is made according to the following reaction scheme.
2 VPO₄+3 NaF [symbol] Na₃V₂(PO₄)₂F₃
A mixture of 2 mol VPO₄ and 3 mol NaF is made, using a mortar and pestle. The mixture is pelletized, and transferred to a temperature-controlled tube furnace equipped with an argon gas flow. The mixture is heated at a ramp rate of about 2°/minute to an ultimate temperature of about 750° C. for 1 hour. The product is then cooled to ambient temperature (about 20° C.). X-ray powder diffraction analysis for the Na₃V₂(PO₄)₂F₃ material indicated the material to be single phase with a tetragonal structure (space group P4₂/mnm). The unit cell parameters (a=9.0304(5) Å, c=10.6891(9) Å) were calculated from a least squares refinement procedure, in fair agreement with the structural analysis for Na₃V₂(PO₄)₂F₃ described by Meins et al., J. Solid State Chem., 148, 260, (1999). (i.e. a=9.047(2) Å, c=10.705(2) Å).

An electrode is made with 84% of the active material, 5% of Super P conductive carbon, and 11-wt % PVdF-HFP co-polymer (Elf Atochem) binder. The electrolyte comprised a 1M LiPF₆ solution in ethylene carbonate/dimethyl carbonate (2:1 by weight) while a dried glass fiber filter (Whatman, Grade GF/A) was used as electrode separator. A commercial crystalline graphite was used as the anode active material. High-resolution electrochemical measurements were performed using the Electrochemical Voltage Spectroscopy (EVS) technique. EVS is a voltage step method, which provides a high-resolution approximation to the open circuit voltage curve for the electrochemical system under investigation. Such technique is known in the art as described by J. Barker in Synth. Met 28, D217 (1989); Synth. Met. 32, 43 (1989); J. Power Sources, 52,185 (1994); and Electrochemica Acta, Vol. 40, No. 11, at 1603 (1995).

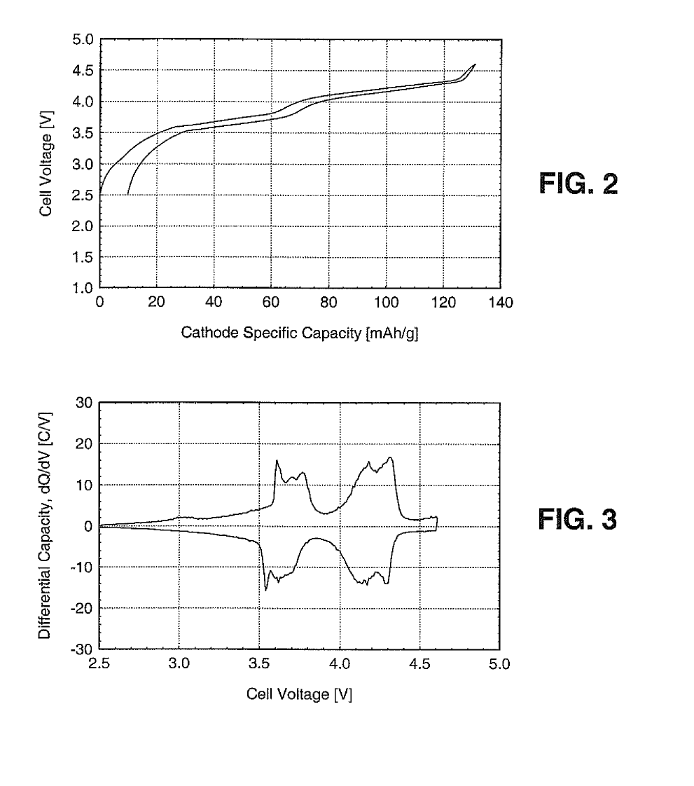

FIGS. 2 and 3 show the voltage profile and differential capacity plots for the first cycle EVS response for the Graphite/1M LiPF₆ (EC/DMC)/Na₃V₂(PO₄)₂F₃ rocking chair cell. In this configuration the only available Li in the system originates from the LiPF₆-based electrolyte phase. Based on a cathode limited system, the actual volume of electrolyte used was carefully controlled so as to allow charging of the graphite active material to an approximate utilization limit of 300 mAh/g or Li_{0.18}C₆.

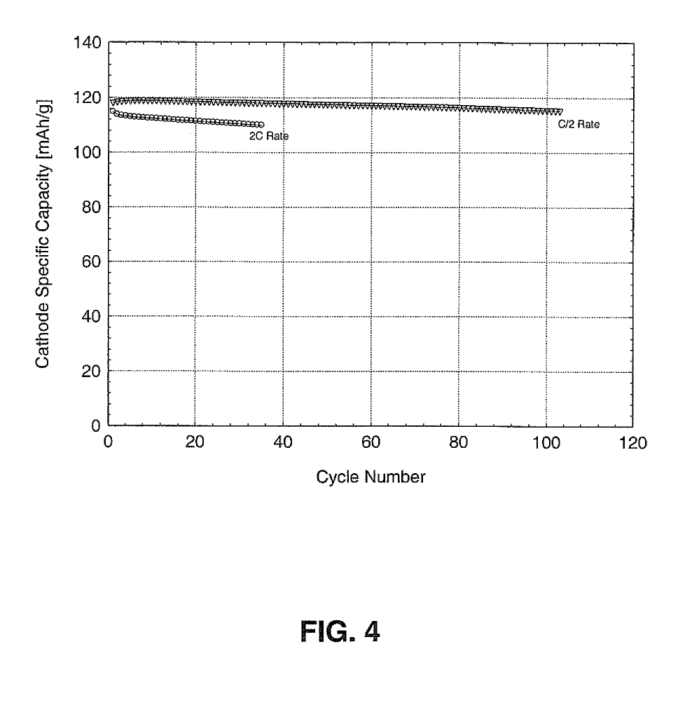

FIG. 4 shows the cycling behavior of representative graphite//Na₃V₂(PO₄)₂F₃ cells. The data was collected at approximate charge/discharge rates of C/2 and 2C. The initial cathode reversible capacity is in the range 115-120 mAh/g and the cells cycle with relatively low capacity fade behavior. The minor decrease in discharge capacity recorded at the two discharge rates is indicative of the excellent rate characteristics of this system.

The examples and other embodiments described herein are exemplary and not intended to be limiting in describing the full scope of compositions and methods of this invention. Equivalent changes, modifications and variations of specific embodiments, materials, compositions and methods may be made within the scope of the present invention, with substantially similar results.

What is claimed is:

1. An electrochemical cell, comprising:
a first electrode comprising an electrode active material comprising at least one electrode active material charge-carrier;
a second electrode; and
an electrolyte comprising at least one electrolyte charge-carrier;
wherein in the electrochemical cell's nascent state the at least one electrolyte charge carrier differs from the at least one electrode active material charge-carrier.

2. The electrochemical cell of claim 1, wherein the second electrode comprises an intercalation active material.

3. The electrochemical cell of claim 1, wherein the electrode active material comprises one electrode active material charge-carrier and the electrolyte comprises one electrolyte charge-carrier, wherein in the electrochemical cell's nascent state, the electrolyte charge carrier differs from the electrode active material charge-carrier.

4. The electrochemical cell of claim 3, wherein in the electrochemical cell's nascent state, the electrode active material charge-carrier is selected from the group consisting of elements from Groups I and II of the Periodic Table, and mixtures thereof.

5. The electrochemical cell of claim 4, wherein in the electrochemical cell's nascent state, the electrolyte charge carrier is lithium.

6. The electrochemical cell of claim 1, wherein in the electrochemical cell's nascent state, the electrode active material is represented by the general formula:
AₐM_{b}(M′O)_{c}(XY₄)_{d}OₑZ_{f};
wherein:
(i) A comprises the at least one electrode active material charge-carrier, and 0<a≦9;
(ii) M and M′ includes at least one redox active element, and 1≦b≦6 and 1≦c≦1;
(iii) XY₄ is selected from the group consisting of X′[O₄₋ₓ,Y′ₓ], X′[O_{4-y},Y′_{2y}], X″S₄, [X_{z}′″,X′_{1-z}]O₄, WO₄, and mixtures thereof, wherein:
(a) X′ and X′″ are each independently selected from the group consisting of P, As, Sb, Si, Ge, V, S, and mixtures thereof;
(b) X″ is selected from the group consisting of P, As, Sb, Si, Ge, V, and mixtures thereof;
(c) W is selected from the group consisting of V, Hf, Zr, Ti and mixtures thereof;
(d) Y′ is selected from the group consisting of a halogen selected from Group 17 of the Periodic Table, S, N, and mixtures thereof; and
(e) 0≦x≦3, 0≦y≦2, 0≦z≦1, and 0≦d≦3;
(iv) O is oxygen, and 0≦e≦15 wherein when e>0, (c,d)=0, and wherein when d>0, e=0; and
(v) Z is selected from the group consisting of a hydroxyl (OH), a halogen selected from Group 17 of the Periodic Table, nitrogen (N), and mixtures thereof, and 0≦f≦4;
wherein A, M, M′, X, Y, Z, a, b, c, x, y, z, d, e and f are selected so as to maintain electroneutrality of the electrode active material in its nascent state.

7. The electrochemical cell of claim 6, wherein in the electrochemical cell's nascent state, A is selected from the group consisting of elements from Groups I and II of the Periodic Table, and mixtures thereof.

8. The electrochemical cell of claim 6, wherein in the electrochemical cell's nascent state, the electrolyte charge carrier is lithium.

9. The electrochemical cell of claim 8, wherein in the electrochemical cell's nascent state, A is Na.

10. The electrochemical cell of claim 6, wherein M and M′ are each independently selected from the group consisting of elements from Groups 4 through 11 of the Periodic Table.

11. The electrochemical cell of claim 6, wherein at least one of M and M′ =MIₙMIIₒ, wherein 0<o+n≦b and each of o and n is greater than zero (0<o,n), wherein MI and MII are each independently selected from the group consisting of redox active elements and non-redox active elements, wherein at least one of MI and MII is redox active.

12. The electrochemical cell of claim 6, wherein in the electrochemical cell's nascent state, the electrode active material is represented by the general formula:
AₐM_{b}(XY₄)_{d}Z_{f},
wherein 1≦b≦3, and wherein A, M, X, Y, Z, a, b, x, y, z, d and f are selected so as to maintain electroneutrality of the electrode active material in its nascent state

13. The electrochemical cell of claim 12, wherein in the electrochemical cell's nascent state, A is selected from the group consisting of elements from Groups I and II of the Periodic Table, and mixtures thereof.

14. The electrochemical cell of claim 12, wherein in the electrochemical cell's nascent state, the electrolyte charge carrier is lithium.

15. The electrochemical cell of claim 14, wherein the electrolyte comprises a lithium salt selected from the group consisting of LiCl₄; LiBF₄; LiPF₆; LiAlCl₄; LiSbF₆; LiSCN; LiCF₃SO₃; LiCF₃CO₂; Li(CF₃SO₂)₂; LiAsF₆; LiN(CF₃SO2)₂; LiB₁₀Cl₁₀; a lithium lower aliphatic carboxylate; LiCl; LiBr; Lil; a chloroboran of lithium; lithium tetraphenylborate; lithium imides; and mixtures thereof.

16. The electrochemical cell of claim 14, wherein in the electrochemical cells nascent state, A is Na.

17. The electrochemical cell of claim 12, wherein M is selected from the group consisting of Ti³⁺, V³⁺, Cr³⁺, Mn³⁺, Fe³⁺, Co³⁺, Ni³⁺, Mo³⁺, Nb³⁺, and mixtures thereof; XY₄=PO₄; d=3 and f=0.

18. The electrochemical cell of claim 12, wherein M is selected from the group consisting of Ti²⁺, V²⁺, Cr²⁺, Mn²⁺, Fe²⁺, Co²⁺, Ni²⁺, Cu²⁺, Mo²⁺, Si²⁺, Sn²⁺, Pb²⁺, and mixtures thereof; XY₄=PO₄; d=1 and f=0.

19. The electrochemical cell of claim 12, wherein M is selected from the group consisting of Ti³⁺, V³⁺, Cr³⁺, Mn³⁺, Fe³⁺, Co³⁺, Ni³⁺, Mo³⁺, Nb³⁺, and mixtures thereof; XY₄=PO₄; and d=2.

20. The electrochemical cell of claim 12, wherein the second electrode comprises an intercalation active material selected from the group consisting of transition metal oxides, metal chalcogenides, carbons, and mixtures thereof.

21. The electrochemical cell of claim 20, wherein the intercalation active material is graphite.

22. The electrochemical cell of claim 6, wherein in the electrochemical cell's nascent state, the electrode active material is represented by the general formula:
AₐM_{b}Oₑ,
wherein 0≦a≦6,1≦b≦6, and 0≦e≦15, and wherein A, M, a, b and e are selected so as to maintain electroneutrality of the electrode active material in its nascent state.

23. The electrochemical cell of claim 22, wherein in the electrochemical cell's nascent state, the electrode active material is represented by the general formula:
AₐNiₜCoᵤM⁴ᵥO₂,
wherein 0<(t+u)≦1, 0≦t<1, and M⁴ is at least one metal selected from Group 2, 12, 13, or 14 of the Periodic Table, and wherein A, M, a, t, u and v are selected so as to maintain electroneutrality of the electrode active material in its nascent state.

24. The electrochemical cell of claim 22, wherein in the electrochemical cell's nascent state, A is selected from the group consisting of elements from Groups I and II of the Periodic Table, and mixtures thereof.

25. The electrochemical cell of claim 22, wherein in the electrochemical cell's nascent state, the electrolyte charge carrier is lithium.

26. The electrochemical cell of claim 25, wherein the electrolyte comprises a lithium salt selected from the group consisting of LiClO₄; LiBF₄; LiPF₆; LiAlCl₄; LiSbF₆; LiSCN; LiCF₃SO₃; LiCF₃CO₂; Li(CF₃SO₂)₂; LiAsF₆; LiN(CF₃SO2)₂; LiB₁₀Cl₁₀; a lithium lower aliphatic carboxylate; LiCl; LiBr; Lil; a chloroboran of lithium; lithium tetraphenylborate; lithium imides; and mixtures thereof.

27. The electrochemical cell of claim 25, wherein in the electrochemical cells nascent state, A is Na.

28. The electrochemical cell of claim 22, wherein the second electrode comprises an intercalation active material selected from the group consisting of transition metal oxides, metal chalcogenides, carbons, and mixtures thereof.

29. The electrochemical cell of claim 28, wherein the intercalation active material is graphite.

30. The electrochemical cell of claim 6, wherein in the electrochemical cell's nascent state, the electrode active material is represented by the general formula:
AₐMn_{b}O₄,
and is characterized as having an inner and an outer region, wherein the inner region comprises a cubic spinel manganese oxide, and the outer region is enriched with Mn⁺⁴ relative to the inner region, 0<a≦2.0, and A, a and b are selected so as to maintain electroneutrality of the electrode active material in its nascent state.

31. The electrochemical cell of claim 30, wherein in the electrochemical cell's nascent state, A is selected from the group consisting of elements from Groups I and II of the Periodic Table, and mixtures thereof.

32. The electrochemical cell of claim 30, wherein in the electrochemical cell's nascent state, the electrolyte charge carrier is lithium.

33. The electrochemical cell of claim 32, wherein the electrolyte comprises a lithium salt selected from the group consisting of LiClO₄; LiBF₄; LiPF₆; LiAlCl₄; LiSbF₆; LiSCN; LiCF₃SO₃; LiCF₃CO₂; Li(CF₃SO₂)₂; LiAsF₆; LiN(CF₃SO2)₂; LiB₁₀Cl₁₀; a lithium lower aliphatic carboxylate; LiCl; LiBr; Lil; a chloroboran of lithium; lithium tetraphenylborate; lithium imides; and mixtures thereof.

34. The electrochemical cell of claim 32, wherein in the electrochemical cells nascent state, A is Na.

35. The electrochemical cell of claim 30, wherein the second electrode comprises an intercalation active material selected from the group consisting of transition metal oxides, metal chalcogenides, carbons, and mixtures thereof.

36. The electrochemical cell of claim 35, wherein the intercalation active material is graphite.

37. The electrochemical cell of claim 6, wherein in the electrochemical cell's nascent state, the electrode active material is represented by the general formula:
Aₐ(M′O)_{c}XO₄Z_{f},
wherein 0<c≦1, X is selected from the group consisting of P, As, Sb, Si, Ge, V, S, and mixtures thereof, and wherein A, M′, X, a, c, and f are selected so as to maintain electroneutrality of the electrode active material in its nascent state.

38. The electrochemical cell of claim 37, wherein in the electrochemical cell's nascent state, A is selected from the group consisting of elements from Groups I and II of the Periodic Table, and mixtures thereof.

39. The electrochemical cell of claim 37, wherein in the electrochemical cell's nascent state, the electrolyte charge carrier is lithium.

40. The electrochemical cell of claim 39, wherein the electrolyte comprises a lithium salt selected from the group consisting of LiClO₄; LiBF₄; LiPF₆; LiAlCl₄; LiSbF₆; LiSCN; LiCF₃SO₃; LiCF₃CO₂; Li(CF₃SO₂)₂; LiAsF₆; LiN(CF₃SO2)₂; LiB₁₀Cl₁₀; a lithium lower aliphatic carboxylate; LiCl; LiBr; Lil; a chloroboran of lithium; lithium tetraphenylborate; lithium imides; and mixtures thereof.

41. The electrochemical cell of claim 39, wherein in the electrochemical cells nascent state, A is Na.

42. The electrochemical cell of claim 37, wherein the second electrode comprises an intercalation active material selected from the group consisting of transition metal oxides, metal chalcogenides, carbons, and mixtures thereof.

43. The electrochemical cell of claim 42, wherein the intercalation active material is graphite.

44. The electrochemical cell of claim 37, wherein moiety (M′O) is a 2+ ion containing a metal (M′) in the 4+ oxidation state.

45. The electrochemical cell of claim 37, wherein M′ is vanadium (V), and XY₄═PO₄.

46. The electrochemical cell of claim 6, wherein in the electrochemical cell's nascent state, the electrode active material is represented by the general formula:
AₐM_{b}WO₄,
wherein:
(i) moieties A and M are as described herein above, wherein 0<a≦2 and 0<b≦1; and
(ii) W is selected from the group consisting of Hf, Ti, Zr, and mixtures thereof; and
wherein A, M, W, a and b are selected so as to maintain electroneutrality of the material in its nascent state.

47. The electrochemical cell of claim 46, wherein in the electrochemical cell's nascent state, A is selected from the group consisting of elements from Groups I and II of the Periodic Table, and mixtures thereof.

48. The electrochemical cell of claim 46, wherein in the electrochemical cell's nascent state, the electrolyte charge carrier is lithium.

49. The electrochemical cell of claim 48, wherein the electrolyte comprises a lithium salt selected from the group consisting of LiClO₄; LiBF₄; LiPF₆; LiAlCl₄; LiSbF₆; LISCN; LiCF₃SO₃; LiCF₃CO₂; Li(CF₃SO₂)₂; LiAsF₆; LiN(CF₃SO2)₂; LiB₁₀Cl₁₀; a lithium lower aliphatic carboxylate; LiCl; LiBr; Lil; a chloroboran of lithium; lithium tetraphenylborate; lithium imides; and mixtures thereof.

50. The electrochemical cell of claim 48, wherein in the electrochemical cells nascent state, A is Na.

51. The electrochemical cell of claim 46, wherein the second electrode comprises an intercalation active material selected from the group consisting of transition metal oxides, metal chalcogenides, carbons, and mixtures thereof.

52. The electrochemical cell of claim 51, wherein the intercalation active material is graphite.

53. The electrochemical cell of claim 46, wherein M is selected from the group consisting of Ni, Co, Fe, Mn, V, Cr and mixtures thereof.
